(19) United States
(12) Patent Application Publication
(10) Pub. No.: US 2017/0349749 A1
(43) Pub. Date: Dec. 7, 2017

(54) COMPOSITE

(71) Applicant: LANXESS DEUTSCHLAND GMBH, COLOGNE (DE)

(72) Inventors: THOMAS DEDERICHS, COLOGNE (DE); THOMAS FRUH, WUPPERTAL (DE); TORSTEN THUST, COLOGNE (DE); ULRICH GIESE, HANNOVER (DE); SEBASTIAN TEICH, HANNOVER (DE)

(73) Assignee: LANXESS DEUTSCHLAND GMBH, COLOGNE (DE)

(21) Appl. No.: 15/537,067

(22) PCT Filed: Dec. 18, 2015
(86) PCT No.: PCT/EP2015/080627

§ 371 Date: Jun. 16, 2017

(30) Foreign Application Priority Data
Dec. 22, 2014 (DE) 202014010030.6

(51) Int. Cl. C08L 77/02; C08L 9/00; B32B 25/08; B32B 27/34; C08L 77/06; C08L 23/20

(52) U.S. Cl. CPC C08L 77/02; C08L 77/06; C08L 23/20; B32B 25/08; B32B 27/34; C08L 9/00

(57) ABSTRACT

The invention relates to a directly adhering composite composed of at least one part composed of at least one polyamide molding compound and at least one part composed of at least one elastomer, preferably obtainable from rubber to be vulcanized or crosslinked with elemental sulfur, wherein at least one part comprises the mixture of polyoctenamer and polybutadiene.

The invention relates to a directly adhering composite composed of at least one part composed of at least one polyamide molding compound and at least one part composed of at least one elastomer, preferably obtainable from rubber to be vulcanized or crosslinked with elemental sulfur, wherein at least one part comprises the mixture of polyoctenamer and polybutadiene.

The individual parts of the composite are macroscopic moldings but not, for example, dispersed particles in a polymer/elastomer blend or polyamide fibers in an elastomer matrix. Such blends are therefore not composites in the sense of the invention.

### PRIOR ART

Composites composed of stiff thermoplastic and elastomeric moldings are typically joined by adhesive bonding, screw connection, mechanical interlocking or with use of an adhesion promoter, since it is not possible to achieve sufficiently strong adhesion in the vast majority of combinations of thermoplastic and elastomer.

In the prior art, there are numerous disclosures of a composite composed of polyamide and elastomer, obtainable from rubber that is to be vulcanized or crosslinked with elemental sulfur, with use of adhesion promoters. The adhesion promoter is applied to the component, either the thermoplastic or elastomer, which has been manufactured first. If the thermoplastic component is produced first, the adhesion promoter is applied to the surface of the thermoplastic, then the rubber mixture to be crosslinked is sprayed on and vulcanized. If the elastomer is manufactured first, the adhesion promoter is applied to the surface thereof before the thermoplastic is sprayed on. Depending on the material combination, a one-layer or two-layer bonding system is used. Adhesion promoters that are used in a customary and preferred manner are mentioned in J. Schnetger “Lexikon der Kautschuktechnik” [Lexicon of Rubber Technology], 3rd edition, Hüthig Verlag Heidelberg, 2004, page 203, and in B. Crowther, “Handbook of Rubber Bonding”, iSmithers Rapra Publishing, 2001, pages 3 to 55. Particular preference is given to using at least one adhesion promoter of the Chemlok® or Chemosil® brand (from Lord) or of the Cilbond® brand (from CIL).

When adhesion promoters are used, the use of environmentally harmful solvents and/or heavy metals is a problem in principle, unless water-based adhesion promoters are used. Generally, the application of an adhesion promoter constitutes an additional operating step which entails an additional operation and therefore takes time and effort.

WO 2014/096392 A1 discloses a directly adhering composite part and the production thereof, said composite part being composed of at least one part produced from at least one polyamide molding compound and at least one part produced from at least one elastomer, without using any adhesion promoter, wherein the polyamide molding compound contains at least 30% by weight of a mixture of
a) 60 to 99.9 parts by weight of polyamide and
b) 0.1 to 40 parts by weight of polyalkenamer,
where the sum total of the parts by weight of a) and b) is 100, the elastomer part has been produced from rubber which is to be crosslinked or vulcanized with elemental sulfur as crosslinking agent, and the polyalkenamer chosen is at least one from the group of polybutadiene, polyisoprene, polyoctenamer (polyoctenylene), polynorbornene (poly-1,3-cyclopentylene-vinylene) and polydicyclopentadiene.

In the effort to improve the composite adhesion of polyamide-based products to give sulfur-crosslinked components, it has now been found that, surprisingly, a mixture of polyoctenamer and polybutadiene leads to another distinct rise therein.

### Invention

The invention provides a directly adhering composite composed of at least one part produced from at least one polyamide molding compound and at least one part produced from at least one elastomer, wherein at least one part comprises the mixture of polyoctenamer and polybutadiene.

Surprisingly, the use of the mixture of polyoctenamer and polybutadiene in the polyamide component leads to a rise in the bond strength of a composite of the two parts to one another, i.e. at least one part produced from a polyamide molding compound and at least one part produced from at least one elastomer, to an extent unachievable by the use of the individual components, with achievement of high bonding values with a bond strength in a 90° peel test based on DIN ISO 813 of well above 3 N/mm.

In addition, the inventive composite composed of at least one polyamide part and at least one elastomer part has adhesion which is stable even at high temperature, for example 120° C., and under the influence of nonpolar media, for example storage in nonpolar solvents, especially toluene.

For clarity, it should be noted that the scope of the present invention encompasses all the definitions and parameters mentioned hereinafter in general terms or specified within areas of preference, in any desired combinations. Unless stated otherwise, all percent figures are percentages by weight. The terms “composite” and “composite part” are used synonymously in the context of the present invention. In the context of the present application, the simple term “elastomer part” is also used for the term “part composed of rubber”. The standards utilized in the context of the present invention are used in the version of each that was valid at the filing date of this application.

The present invention also relates to a method of increasing the bond strength of a directly adhering composite which has preferably been assembled without adhesion promoter, composed of at least one polyamide-based part and at least one part produced from rubber, preferably rubber to be crosslinked or vulcanized with elemental sulfur as crosslinking agent, characterized in that the molding compound of at least one part, preferably the molding compound of the at least one polyamide-based part, is additized with a mixture comprising polyoctenamer and polybutadiene.

The present application also provides for the use of a mixture of polyoctenamer and polybutadiene, preferably in polyamides, for enhancing the bond strength of a directly adhering composite composed, preferably without adhesion promoter, of at least one polyamide-based part and at least one part made from rubber, preferably rubber to be crosslinked or vulcanized with elemental sulfur as crosslinking agent.

The invention also provides the mixture of polyoctenamer and polybutadiene and for the use thereof, preferably as masterbatch, for production of an above-described composite. A masterbatch, according to http://de.wikipedia.org/wiki/Masterbatch, is a plastics additive in the form of pellets having contents of additives, the contents being higher than in the final application. A masterbatch for use in accordance with the invention is added here to the polyamide to alter its properties—here the improvement in the bond strength to the rubber component. Masterbatches increase processing reliability compared to pastes, powders or liquid additive mixtures and have very good processibility.

The present invention also provides products, especially products that conduct liquid media or gaseous media, comprising at least one composite of the invention, and for the use of the composites of the invention in products that conduct liquid media or gaseous media, preferably in the chemical industry, the domestic appliances industry or the motor vehicle industry. Especially preferably, the composites of the invention are used in the form of seals, membranes, gas pressure storage means, hoses, housings for motors, pumps and electrically operated tools, rollers, tires, couplings, buffer stops, conveyor belts, drive belts, multilayer laminates or multilayer films, and sound- and vibration-dampening components.

The present invention additionally relates to a method for sealing products that contain liquid media and/or gaseous media using at least one inventive composite.

### PREFERRED EMBODIMENTS OF THE INVENTION

Preferably in accordance with the invention, the molding compound to be processed for the polyamide part is additized with a mixture comprising polyoctenamer and polybutadiene. More preferably, the polyoctenamer has a viscosity number J in the range from 100 to 150 ml/g, preferably in the range from 120 to 140 ml/g.

Preferably, the invention relates to a directly adhering composite composed of at least one piece produced from at least one polyamide molding compound and at least one piece produced from at least one elastomer, in which the polyamide molding compound, to an extent of at least 30% by weight, comprises a mixture of polyamide, polyoctenamer and polybutadiene and the elastomer part is produced from rubber to be crosslinked or vulcanized with elemental sulfur as crosslinking agent.

The invention preferably relates to a directly adhering composite composed of at least one part produced from at least one polyamide molding compound and at least one part produced from at least one elastomer, in which the polyamide molding compound, to an extent of at least 30% by weight, comprises a mixture of
a) 60 to 99.9 parts by weight of polyamide and
b) 0.1 to 40 parts by weight of polyoctenamer and polybutadiene,
   where the sum total of the parts by weight of a) and b) is 100 and the elastomer part is produced from rubber to be crosslinked or vulcanized with elemental sulfur as crosslinking agent.

For clarification, it should be noted that, in the cases in which the polyamide molding compound comprises a mixture of a) and b) to an extent of at least 30% by weight, the polyamide molding compound additionally comprises, in each case depending on the amount of components a) and b) actually used, up to 70% by weight of additives, preferably at least one additive of the components (I) to (VIII) added at a later stage. If the polyamide molding compound consists of components a) and b) to an extent of 100% by weight, no further additives are present.

The present invention more preferably relates to a directly adhering composite composed of at least one part produced from at least one polyamide molding compound and at least one part produced from at least one elastomer, without using any adhesion promoter, in which the polyamide molding compound, to an extent of at least 30% by weight, comprises a mixture of
a) 60 to 99.9 parts by weight of polyamide and
b) 0.1 to 40 parts by weight of polyoctenamer and polybutadiene,
   where the sum total of the parts by weight of a) and b) is 100 and the elastomer part is produced from rubber to be crosslinked or vulcanized with elemental sulfur as crosslinking agent.

The present invention most preferably relates to a directly adhering composite composed of at least one part produced from at least one polyamide molding compound and at least one part produced from at least one elastomer, especially without using any adhesion promoter, characterized in that the polyamide molding compound contains at least 30% by weight, preferably at least 45% by weight, more preferably at least 55% by weight and especially preferably at least 65% by weight of a mixture of
a) 60 to 99.9 parts by weight, preferably 75 to 99.8 parts by weight and more preferably 85 to 99.7 parts by weight and most preferably 88 to 99.5 parts by weight of polyamide and
b) 0.1 to 40 parts by weight, preferably 0.2 to 25 parts by weight, more preferably 0.3 to 15 parts by weight and most preferably 0.5 to 12 parts by weight of a mixture of polyoctenamer and polybutadiene,
   where the sum total of the parts by weight of a) and b) is 100 and the elastomer part is produced from rubber to be crosslinked or vulcanized with elemental sulfur as crosslinking agent.

The invention preferably relates to a method of increasing the bond strength of a composite which has preferably been assembled without adhesion promoter, composed of at least one polyamide-based part and at least one part produced from rubber to be crosslinked or vulcanized with elemental sulfur as crosslinking agent, characterized in that the molding compound to be processed for the polyamide part is additized with a mixture comprising polyoctenamer and polybutadiene and then the composite is produced by at least one shaping method from the group of extrusion, flat film extrusion, film blowing, extrusion blow molding, coextrusion, calendering, casting, compression methods, injection embossing methods, transfer compression methods, transfer injection compression methods or injection molding or special methods thereof, especially gas injection methodology, preferably by 2-component injection molding.

This process involves either preferably contacting the part composed of the polyamide molding compound with an elemental sulfur-containing rubber component and exposing it to the vulcanization conditions of the rubber, or preferably contacting the part composed of elastomer crosslinked with elemental sulfur as crosslinking agent with a polyamide molding compound.

### Polyoctenamer

Especially preferably, the polyoctenamer added to the polyamide molding compound of the polyamide part is 1,8-trans-polyoctenamer, for which the abbreviation TOR (1,8-trans-polyoctenamer rubber) is used in the context of the present invention. 1,8-trans-Polyoctenamer [CAS No. 28730-09-8], also referred to as trans-polyoctenylene, which is to be used with especial preference in accordance with the invention, is obtained by ring-opening metathesis polymerization from cyclooctene, and it comprises both macrocyclic and linear polymers. TOR is a low molecular weight specialty rubber having a bimodal molecular weight distribution. The bimodal molecular weight distribution of TOR arises from the fact that the low molecular weight constituents are generally within a weight-average molecular weight range from 200 to 6000 g/mol, and the high polymeric constituents within a weight-average molecular weight range from 8000 to 400 000 g/mol (A. Dräxier, Kautschuk, Gummi, Kunststoffe, 1981, volume 34, issue 3, pages 185 to 190).

The molecular weight is determined in the context of the present invention by viscosity measurement with a capillary viscometer. The solution viscosity is a measure of the average molecular weight of a plastic. The determination is effected on dissolved polymer, using various solvents, especially formic acid, m-cresol, tetrachloroethane, etc., and concentrations. The measurement in the capillary viscometer gives the viscosity number J (ml/g).

Viscosity measurements in solution are used to determine the K value, a molecular parameter by which the flow properties of polymers can be determined.

If η=viscosity, in simplified form: [η]=2.303*(75 k²+k) with K value=1000 k.

The determination of the viscosity number J can then be conducted in a simple manner from the K value according to DIN 53726.

$$J = ( \frac{η}{{η}_{0}} - 1 ) \cdot \frac{1}{c}$$

For practical use, there exist calculation tables for K value to viscosity number J, and the K value and viscosity number are proportional to the mean molecular masses of the polymers.

It is possible via viscosity number J to monitor the processing and performance characteristics of plastics. A thermal load on the polymer, aging processes or exposure to chemicals, weathering and light can be investigated by means of comparative measurements. The process is standardized for standard plastics, for example in DIN EN ISO 307 for polyamides and in DIN ISO 1628-5 for polyesters.

The 1,8-trans-polyoctenamer for use in accordance with the invention is prepared according to EP 0 508 056 A1. The weight-average molecular weight Mw of the 1,8-trans-polyoctenamer for use with preference in accordance with the invention is preferably in the range from 80 000 to 120 000 g/mol, more preferably about 90 000 g/mol.

According to the invention, the viscosity number J is determined according to ISO 1628-1 at 23° C.:

dissolve 10 g of polyoctenamer in 1 l of toluene;
measuring instrument: Schott Visco System AVS 500;
capillary type no. 53713 from Schott.

In a preferred embodiment, the crystalline fraction of the 1,8-trans-polyoctenamer for use with preference in accordance with the invention at room temperature (25° C.) is in the range from 20% to 30%. Especially preferably in accordance with the invention, 1,8-trans-polyoctenamer rubber having a weight-average molecular weight Mw of 90 000 g/mol and a trans/cis double bond ratio of 80:20, i.e. Vestenamer® 8012, is used.

1,8-trans-Polyoctenamer is commercially available as Vestenamer® 8012, according to manufacturer data a 1,8-trans-polyoctenamer rubber having a weight-average molecular weight Mw of 90 000 g/mol and a trans/cis double bond ratio of 80:20, and a viscosity number J, measured according to ISO 1628-1 at 23° C., of 120 ml/g, named here as cyclooctone homopolymer [CAS No. 25267-51-0], and also Vestenamer® 6213, according to manufacturer data a 1,8-trans-polyoctenamer rubber having a weight-average molecular weight of Mw 1.1*10⁵ g/mol and a trans/de double bond ratio in the region of 62:38, and a viscosity number J, measured according to ISO 1628-1 at 23° C., of 130 ml/g (Product Information from Evonik Industries AG, Marl, Germany; Handbook of Elastomers, edited by A. K. Bhowmick, H. L Stephens, 2nd revised edition, Marcel Dekkers Inc. New York, 2001, pages 698 to 703).

According to the invention, the polyoctenamer in the polyamide molding compound for the polyamide part is used in combinations with polybutadiene, preferably in the form of a masterbatch.

### Polybutadiene

Polybutadiene (BR) [CAS No. 9003-17-2] comprises two different classes of polybutadiene in particular. The first class has a 1,4-cis content of at least 90% and is prepared with the aid of Ziegler/Natta catalysts based on transition metals. Preference is given to using catalyst systems based on Ti, Ni, Co and Nd (Houben-Weyl, Methoden der Organischen Chemie, Thieme Verlag, Stuttgart, 1987, volume E 20, pages 798 to 812; Ullmann's Encyclopedia of Industrial Chemistry, Vol A 23, Rubber 3. Synthetic, VCH Verlagsgesellschaft mbH, D-69451 Weinheim, 1993, p. 239-364). The second polybutadiene class is prepared with lithium or sodium catalysts and has 1,2-vinyl contents of 10% to 95%.

Polybutadienes having a low molecular weight may be liquid at room temperature. Generally, liquid polybutadienes can be prepared via a synthesis, i.e. a reaction to build up the molecular weight, or via a degradation of polybutadiene having a high molecular weight. By synthetic means, liquid polybutadienes can be prepared as described above via Ziegler-Natta polymerization or via anionic polymerization (H.-G. Elias, “Macromolecules, Volume 2: Industrial Polymers and Syntheses”, WILEY-VCH Verlag GmbH, Weinheim, 2007, p. 242 to 245; H.-G. Elias, “Macromolecules, Volume 4: Applications of Polymers”, WILEY-VCH Verlag GmbH, Weinheim, 2007, p. 284 to 285).

Preferably, polybutadienes having a number-average molecular weight Mn in the range from 800 to 20 000 g/mol, more preferably in the range from 1500 to 15 000 g/mol, most preferably in the range from 2000 to 9000 g/mol, and/or having a dynamic viscosity, measured by the cone-plate method to DIN 53019, at standard pressure and at a temperature of 25° C., in the range from 100 to 15 000 mPas, more preferably in the range from 300 to 10 000 mPas, most preferably in the range from 500 to 5000 mPas, are used. These are notable in that they are liquid at room temperature (25° C.). Liquid polybutadienes of this kind are supplied, for example, by Synthomer Ltd., Harlow, Essex, UK, as Lithene®, especially Lithene® ultra N4-5000, a liquid polybutadiene having a dynamic viscosity at 25° C. (DIN 53019) of 4240 mPas having a number-average molecular weight Mn in the region of 5000 g/mol (manufacturer figure) (see Synthomer Ltd., Lithene® Liquid Polybutadiene, Product Range, Harlow, Essex, UK). Alternative liquid polybutadienes for use are supplied by Evonik Industries AG, Marl, Germany, under the Polyvest® name, especially Polyvest® 110, a liquid polybutadiene having a dynamic viscosity at 25° C. (DIN 53019) of 650 mPas and a number-average molecular weight Mn in the region of 2600 g/mol (manufacturer figure), or by Kuraray Europe GmbH, Hattersheim am Main, Germany, under the LBR name, especially LBR-307B [CAS No. 9003-17-2], a liquid polybutadiene having a dynamic viscosity at 25° C. (DIN 53019) of 2210 mPas and a weight-average molecular weight Mw in the region of 8000 g/mol (manufacturer figure) (see Kuraray Europe GmbH, Kuraray Liquid Rubber, Hattersheim am Main, Germany). The list of liquid polybutadienes for use with preference is not restricted to the products and manufacturers specified. It is also possible to use alternatives.

Preferably, the polyoctenamer and the polybutadiene are used in a mass ratio in the range from 1 part polyoctenamer:20 parts polybutadiene to 30 parts polyoctenamer:1 part polybutadiene, more preferably in a mass ratio n the range from 1 part polyoctenamer:10 parts polybutadiene to 20 parts polyoctenamer:1 part polybutadiene, most preferably in a mass ratio in the range from 1 part polyoctenamer:5 parts polybutadiene to 10 parts polyoctenamer:1 part polybutadiene.

In a preferred embodiment, it is a feature of the polyamide component that it does not contain any coagent. Coagents are used for the peroxidic crosslinking of rubbers and lead to an increased crosslinking yield. In chemical terms, coagents are polyfunctional compounds which react with polymer free radicals and form more stable free radicals (F. Röthemeyer, F. Sommer “Kautschuktechnologie”, 2nd revised edition, Carl Hanser Verlag Munich Vienna, 2006, pages 315 to 317; J. Schnetger “Lexikon der Kautschuktechnik” 3rd edition, Hüthig Verlag Heidelberg, 2004, pages 82 to 83). In a preferred embodiment, it is a feature of the polyamide component that it does not contain any coagent from the group of ethylene glycol dimethacrylate (EDMA), trimethylolpropane trimethacrylate (TMPTMA, TRIM), trimethylolpropane triacrylate (TMPTA), hexane-1,6-diol diacrylate (HDDA), hexane-1,6-diol dimethacrylate (HDDMA), butanediol dimethacrylate, zinc diacrylate, zinc dimethacrylate, triallyl cyanurate (TAC), triallyl isocyanurate (TAIC), diallyl terephthalate, triallyl trimellitate (TATM) or N,N′-m-phenylenebismaleimide (MPBM, HVA-2).

### Rubber Component

The rubbers that are to be vulcanized or crosslinked with elemental sulfur and are to be used in the elastomer part of the inventive composite are elastomers obtainable by a vulcanization process. Vulcanization is understood to mean an industrial chemical process developed by Charles Goodyear, in which rubber is made resistant to atmospheric and chemical influences and to mechanical stress under the influence of time, temperature and pressure and by means of suitable crosslinking chemicals.

According to the prior art, sulfur vulcanization is accomplished by heating a rubber mixture comprising raw rubber, sulfur in the form of soluble sulfur and/or in the form of insoluble sulfur and/or sulfur-donating substances, which include, for example, the organic additives commonly known as sulfur donors in the rubber industry, and especially disulfur dichloride (S₂Cl₂), catalysts, auxiliaries and possibly further fillers. An additive added to the rubber component may be at least one vulcanization accelerator suitable for the sulfur vulcanization.

In the prior art, a distinction is made between five sulfur-based crosslinking systems which differ in the amount of added sulfur or sulfur donor and in the ratio of sulfur or sulfur donor to vulcanization accelerator.

The “conventional” sulfur crosslinking system contains 2.0 to 3.5 phr of sulfur (phr=parts per hundred of rubber, i.e. parts by weight based on 100 parts by weight of rubber) and 0.5 to 1.0 phr of accelerator. In the “semi-EV” crosslinking system (EV=efficient vulcanization), 1.0 to 2.0 phr of sulfur and 1.0 to 2.5 phr of accelerator are used. The “EV” crosslinking system contains 0.3 to 1.0 phr of sulfur and 2.0 to 6.0 phr of accelerator. If 0.3 to 0.6 phr of sulfur, 3.0 to 6.0 phr of accelerator and 0.0 to 2.0 phr of sulfur donor are used, this is referred to as a “low-sulfur EV” crosslinking system. In the fifth sulfur-based crosslinking system, which is not for use in accordance with the invention, the “sulfur donor crosslinking system” does not contain any elemental sulfur (0.0 phr); instead, 0.0 to 2.0 phr of accelerator and 1.0 to 4.0 phr of sulfur donor are used. The sulfur donors which are used in the “sulfur donor crosslinking system” act as vulcanizing agents (F. Röthemeyer, F. Sommer “Kautschuktechnologie”, 2nd revised edition, Carl Hanser Verlag Munich Vienna, 2006, pages 291 to 295).

In one embodiment, the elastomer component used in the inventive composite is a rubber that is to be vulcanized or crosslinked with elemental sulfur as crosslinking agent, in the additional presence of at least one sulfur crosslinking system from the group of conventional sulfur crosslinking system, semi-EV crosslinking system, EV crosslinking system and low-sulfur EV crosslinking system.

In all cases, the crosslinking system may comprise, as well as what are called the main accelerators, different and optionally also a plurality of what are called second accelerators. The nature, dosage and combination thereof is matched to the respective application and is additionally different according to the rubber type. In the vulcanization process with sulfur, the long-chain rubber molecules are crosslinked by sulfur bridges. As a result, the plastic properties of the rubber or rubber mixture are lost, and the material is converted from the plastic to an elastic state by means of the process of vulcanization.

The elastomer that forms in this process of vulcanization, also called vulcanized rubber, has permanent elastomeric properties compared to the reactant, returns to its original state in each case under mechanical stress, and has a higher tear strength, elongation and resistance to aging and weathering influences.

The elasticity of a sulfur-crosslinked elastomer component depends on the number of sulfur bridges. The more sulfur bridges are present, the harder the vulcanized rubber. The number and length of sulfur bridges is dependent in turn on the amount of sulfur added, the nature of the crosslinking system and the duration of the vulcanization.

The elastomer component which is obtainable from rubber vulcanized or crosslinked with elemental sulfur and is to be used in accordance with the invention in the composite is notable for the presence of C═C double bonds.

These rubbers containing C═C double bonds are preferably those based on dienes. Particular preference is given in accordance with the invention to rubbers which contain double bonds and, coming from industrial production, have a gel content of less than 30%, preferably less than 5%, especially less than 3%, and are referred to as “R” or “M” rubbers according to DIN/ISO 1629. “Gel content” in the context of the present invention means the proportion of three-dimensionally crosslinked polymeric material that is no longer soluble but is swellable.

Rubbers that are to be crosslinked with elemental sulfur as crosslinking agent and are preferred for the elastomer part in accordance with the invention are those from the group of natural rubber (NR), ethylene-propylene-diene rubbers (EPDMs), styrene/diolefin rubbers, preferably styrene/butadiene rubber (SBR), especially E-SBR, polybutadiene rubber (BR), polyisoprene (IR), butyl rubber, especially isobutene/isoprene rubber (IIR), halobutyl rubber, especially chloro- or bromobutyl rubber (XIIR), nitrile rubber (NBR), hydrogenated nitrile rubber (H-NBR), carboxylated butadiene/acrylonitrile rubber (XNBR) or polychloroprene (CR). If it is possible to obtain rubbers from more than one synthesis route, lot example from emulsion or from solution, all options are always meant. The aforementioned rubbers are sufficiently well known to those skilled in the art and are commercially available from a wide variety of different suppliers.

In addition, it is also possible to use mixtures of two or more of the aforementioned rubbers. These mixtures are also referred to as polymer blends of rubbers or as rubber blends (J. Schnetger “Lexikon der Kautschuktechnik” 3rd edition, Hüthig Verlag Heidelberg, 2004, pages 375 to 377). Rubber blends for use with preference in accordance with the invention are mixtures of NR as matrix phase and BR as dispersed rubber phase with BR contents up to 50 phr and of BR as matrix phase and SBR or CR as dispersed rubber phase with SBR or CR contents up to 50 phr.

Especial preference is given in accordance with the invention to using at least natural rubber (NR) as rubber to be vulcanized or crosslinked with elemental sulfur for the elastomer part.

The natural rubber (NR) [CAS No. 9006-04-6] which is to be crosslinked with elemental sulfur and is especially preferred in accordance with the invention for the elastomer part in the inventive composite part, in chemical terms, is a polyisoprene having a cis-1,4 content of >99% with mean molecular weights of 2·10⁶ to 3·10⁷ g/mol. NR is synthesized by a biochemical route, preferably in the plantation plant Hevea Brasillensis. Natural rubbers are commercially available, for example, as products from the SMR product series (Standard Malaysian Rubber) from Pacidunia Sdn. Bhd. or from the SVR product series (Standard Vietnamese Rubber) from Phu An Imexco. Ltd. (J. Schnetger “Lexikon der Kautschuktechnik” 3rd edition, Hüthig Verlag Heidelberg, 2004, pages 331 to 338).

In an alternatively preferred embodiment, the rubber which is to be crosslinked with elemental sulfur and is used for the elastomer part in the inventive composite is EPDM rubber. EPDM [CAS No. 25038-36-2] comprises polymers which are prepared by terpolymerization of ethylene and greater proportions of propylene, and also a few % by weight of a third monomer having diene structure. The diene monomer provides the double bonds for the vulcanization that follows. Diene monomers used are predominantly cis,cis-1,5-cyclooctadiene (COD), exo-dicyclopentadiene (DCP), endo-dicyclopentadiene (EDCP), 1,4-hexadiene (HX), 5-ethylidene-2-norbornene (ENB) and also vinylnorbornene (VNB).

EPDM rubber is prepared in a known manner by polymerizing a mixture of ethene and propene and a diene in the presence of Ziegler-Natta catalyst systems, for example vanadium compounds with organoaluminum cocatalysts, or metallocene catalyst systems (J. Schnetger “Lexikon der Kautschuktechnik” 3rd edition, Hüthig Verlag Heidelberg, 2004, pages 144 to 146). In general, a mixture of more than 25% by weight of ethene, more than 25% by weight of propene and 1% to 10% by weight, preferably 1% to 3% by weight, of a nonconjugated diene such as bicyclo[2.2.1]heptadiene, 1,5-hexadiene, 1,4-dicyclopentadiene, 5-ethylidenenorbornene and also vinylnorbornene (VNB) is polymerized.

EPDM rubbers are obtainable, for example, as products from the product series of the Keltan® brand from Lanxess Deutschland GmbH, or else by the methods familiar to the person skilled in the art.

In an alternative preferred embodiment, the rubber which is to be crosslinked with elemental sulfur and is used for the elastomer part in the Inventive composite part is SBR rubber, also referred to as vinylaromatic/diene rubber. SBR rubbers or vinylaromatic/diene rubbers [CAS No. 9003-55-8] are understood to mean rubbers based on vinylaromatics and dienes, including both solution vinylaromatic/diene rubbers such as solution SBR, abbreviated to “S-SBR”, and emulsion vinylaromatic/diene rubbers, such as emulsion SBR, abbreviated to E-SBR.

S-SBR is understood to mean rubbers which are produced in a solution process based on styrene as vinylaromatic and butadiene as diene (H. L. Hsieh, R. P. Quirk, Marcel Dekker Inc. New York-Basle 1996; I. Franta Elastomers and Rubber Compounding Materials; Elsevier 1989, pages 73-74, 92-94; Houben-Weyl, Methoden der Organischen Chemie, Thieme Verlag, Stuttgart, 1987, volume E 20, pages 114 to 134; Ullmann's Encyclopedia of Industrial Chemistry, vol. A 23, Rubber 3. Synthetic, VCH Verlagsgeselischaft mbH, D-69451 Weinheim, 1993, p. 240-364). Preferred vinylaromatic monomers are styrene, o-, m- and p-methylstyrene, technical methylstyrene mixtures, p-tert-butylstyrene, α-methylstyrene, p-methoxystyrene, vinylnaphthalene, divinylbenzene, trivinylbenzene and divinylnaphthalene. Particular preference is given to styrene. The content of polymerized vinylaromatic is preferably in the range from 5% to 50% by weight, more preferably in the range from 10% to 40% by weight. Preferred diolefins are 1,3-butadiene, isoprene, 1,3-pentadiene, 2,3-dimethylbutadiene, 1-phenyl-1,3-butadiene and 1,3-hexadiene. Particular preference is given to 1,3-butadiene and isoprene. The content of polymerized dienes is in the range from 50% to 95% by weight, preferably in the range from 60% to 90% by weight. The content of vinyl groups in the polymerized diene is in the range of 10% to 90% by weight, the content of 1,4-trans double bonds is in the range from 20% to 80% by weight and the content of 1,4-cis double bonds is complementary to the sum total of vinyl groups and 1,4-trans double bonds. The vinyl content of the S-SBR is preferably >20% by weight.

The polymerized monomers and the different diene configurations are typically distributed randomly in the polymer. Rubbers having a blockwise structure, which are referred to as integral rubber, shall also be covered by the definition of S-SBR (A) (K.-H. Nordasiek, K.-H. Klepert, GAK Kautschuk Gummi Kunststoffe 33 (1980), no. 4, 251-255).

S-SBR shall be understood to mean both linear and branched or end group-modified rubbers. For example, such types are specified in DE 2 034 989 A1. The branching agent used is preferably silicon tetrachloride or tin tetrachloride.

These vinylaromatic/diene rubbers are produced especially by anionic solution polymerization, i.e. by means of an alkali metal- or alkaline earth metal-based catalyst in an organic solvent.

The solution-polymerized vinylaromatic/diene rubbers advantageously have Mooney viscosities (ML 1+4 at 100° C.) in the range of 20 to 150 Mooney units, preferably in the range of 30 to 100 Mooney units. Oil-free S-SBR rubbers have glass transition temperatures in the range of −80° C. to +20° C., determined by differential thermoanalysis (DSC). “Oil-free” in the context of the present invention means that no oil has been mixed into the rubber in the production process.

E-vinylaromatic/diene rubber is understood to mean rubbers which are produced in an emulsion process based on vinylaromatics and dienes, preferably conjugated dienes, and optionally further monomers (Ullmann's Encyclopedia of Industrial Chemistry, vol. A 23, Rubber 3. Synthetic, VCH Verlagsgesellschaft mbH, D-69451 Weinheim, 1993, p. 247-251). Preferred vinylaromatics are styrene, p-methylstyrene and alpha-methylstyrene. Preferred dienes are especially butadiene and isoprene. Further monomers are especially acrylonitrile. The content of copolymerized vinylaromatic is in the range from 10% to 60% by weight. The glass transition temperature is typically in the range from −50° C. to +20° C. (determined by means of DSC) and the Mooney viscosities (ML 1+4 at 100° C.) are in the range from 20 to 150 Mooney units. Especially the high molecular weight E-SBR types having Mooney viscosities of >80 ME may contain oils in amounts of 30 to 100 parts by weight based on 100 parts by weight of rubber. The oil-free E-SBR rubbers have glass transition temperatures of −70° C. to +20° C., determined by differential thermoanalysis (DSC).

Both E-SBR and S-SBR can also be used in oil-extended form in the elastomer components for the elastomer part in the inventive composite. “Oil-extended” in the context of the present invention means that oils have been mixed into the rubber in the production process. The oils serve as plasticizers. The oils that are customary in Industry and are known to those skilled in the art are employed here. Preference is given to those containing a low level, if any, of polyaromatic hydrocarbons. TDAE (treated distillate aromatic extract), MES (mild extraction solvate) and naphthenic oils are suitable.

In an alternative preferred embodiment, the rubber which is to be crosslinked with elemental sulfur and is used for the rubber part in the inventive composite is polybutadiene (BR) [CAS No. 9003-17-2]. Polybutadiene (BR) comprises two different classes of polybutadiene in particular. The first class has a 1,4-cis (1,4-polybutadiene [CAS No. 25038-44-2]) content of at least 90% and is prepared with the aid of Ziegler/Natta catalysts based on transition metals. Preference is given to using catalyst systems based on Ti, Ni, Co and Nd (Houben-Weyl, Methoden der Organischen Chemie, Thieme Verlag, Stuttgart, 1987, volume E 20, pages 798 to 812; Ullmann's Encyclopedia of industrial Chemistry, Vol A 23, Rubber 3. Synthetic, VCH Verlagsgesellschaft mbH, D-69451 Weinheim, 1993, p. 239-364). The glass transition temperature of these polybutadienes is preferably <−90° C. (determined by means of DSC).

The second polybutadiene class is prepared with lithium catalysts and has vinyl contents in the range from 10% to 80%. The glass transition temperatures of these polybutadiene rubbers are in the range from −90° C. to +20° C. (determined by means of DSC).

In an alternative preferred embodiment, the rubber which is to be crosslinked with elemental sulfur and is used for the rubber part in the inventive composite is polyisoprene (IR). Polyisoprene (IR) typically has a 1,4-cis content of at least 70%. The term IR includes both synthetic 1,4-cis-polyisoprene [CAS No. 104389-31-3] and natural rubber (NR). IR is produced synthetically both by means of lithium catalysts and with the aid of Ziegler/Natta catalysts, preferably with titanium and neodymium catalysts (Houben-Weyl, Methoden der Organischen Chemie, Thieme Verlag, Stuttgart, 1987, volume E 20, pages 822 to 840; Ullmann's Encyclopedia of Industrial Chemistry. Vol. A 23, Rubber 3. Synthetic, VCH Verlagsgesellschaft mbH, D-69451 Weinheim, 1993, p. 239-364). Preference is given to using natural rubber.

3,4-Polyisoprene, which has glass transition temperatures in the range from −20 to +30° C., is also covered by IR.

In an alternative preferred embodiment, the rubber which is to be crosslinked with elemental sulfur and is used for the elastomer part in the inventive composite is nitrile rubber (NBR). NBR [CAS No. 9003-18-3] or [CAS No. 9005-98-5] is obtained by copolymerization of acrylonitrile and butadiene in mass ratios in the range from about 51:48 to 82:18. It is produced virtually exclusively in aqueous emulsion. The resulting emulsions are processed to give the solid rubber for use in the context of this invention (J. Schnetger “Lexikon der Kautschuktechnik” 3rd edition, Hüthig Verlag Heidelberg, 2004, pages 28-29).

In an alternative preferred embodiment, the rubber which is to be crosslinked with elemental sulfur and Is used for the rubber part in the inventive composite is hydrogenated nitrile rubber (H-NBR). H-NBR is produced via complete or partial hydrogenation of NBR in nonaqueous solution using specific catalysts (e.g. pyridine-cobalt complexes or rhodium, ruthenium, iridium or palladium complexes) (J. Schnetger “Lexikon der Kautschuktechnik” 3rd edition, Hüthig Verlag Heidelberg, 2004, page 30).

In an alternative preferred embodiment, the rubber which is to be crosslinked with elemental sulfur and is used for the elastomer part in the inventive composite is carboxylated butadiene/acrylonitrile rubber (XNBR). XNBR is produced via terpolymerization of butadiene, acrylonitrile and acrylic acid or methacrylic acid. The proportion of the carboxylic acid is between 1% and 7% by weight (F. Röthemeyer, F. Sommer “Kautschuktechnologie”, 2nd revised edition, Card Hanser Verlag Munich Vienna, 2006, page 112).

In an alternative preferred embodiment, the rubber which is to be crosslinked with elemental sulfur and is used for the rubber part in the inventive composite is butyl rubber (IIR), especially isobutene/isoprene rubber. Butyl rubber is produced via a copolymerization of isoprene and isobutylene (J. Schnetger “Lexikon der Kautschuktechnik” 3rd edition, Hüthig Verlag Heidelberg, 2004, pages 69 to 71).

In an alternative preferred embodiment, the rubber which is to be crosslinked with elemental sulfur and is used for the rubber part in the inventive composite is halobutyl rubber (XIIR), especially chlorobutyl rubber (CIIR) or bromobutyl rubber (BIIR). Chlorobutyl rubber (CIIR) [CAS No. 68081-82-3] is produced by introducing chlorine gas into a butyl rubber solution (J. Schnetger “Lexikon der Kautschuktechnik” 3rd edition, Hüthig Verlag Heidelberg, 2004, page 75). Bromobutyl rubber (BIIR) [CAS No. 308063-43-6] is produced by treating butyl rubber in solution with bromine (J. Schnetger “Lexikon der Kautschuktechnik” 3rd edition, Hüthig Verlag Heidelberg, 2004, pages 66 to 67).

In an alternative preferred embodiment, the rubber which is to be crosslinked with elemental sulfur and is used for the elastomer part in the inventive composite is polychloroprene (CR). Polychloroprene [CAS No. 9010-98-4] is prepared from chloroprene (2-chloro-1,3-butadiene), optionally in the presence of dichlorobutadiene or sulfur as comonomers, in an emulsion polymerization. Through use of specific chain transfer agents, such as mercaptans, for example n-dodecyl mercaptan, or xanthogen disulfide, during the polymerization, it is possible to produce what are called mercaptan CR types or xanthogen disulfide CR types, which can be crosslinked with metal oxides, vulcanization accelerators and sulfur. It is possible here to use specific accelerator systems, especially thioureas (ETU, DBTU, TBTU, DETU, MTT) (J. Schnetger “Lexikon der Kautschuktechnik” 3rd edition, Hüthig Verlag Heidelberg, 2004, pages 78 to 81; F. Röthemeyer, F. Sommer “Kautschuktechnologie”, 2nd revised edition, Carl Hanser Verlag Munich Vienna, 2006, pages 15 to 163).

Preferably, the rubber which is to be crosslinked with elemental sulfur and is used for the rubber part in the inventive composite is at least one from the group of natural rubber (NR), ethylene-propylene-diene rubbers (EPDMs) [CAS No. 25038-36-2], styrene/diolefin rubbers, preferably styrene/butadiene rubber (SBR) [CAS No. 9003-55-8], especially E-SBR [CAS No. 56-81-5], polybutadiene rubber (BR) [CAS No. 9003-17-2], polyisoprene (IR), butyl rubber, especially isobutene/isoprene rubber (IIR), halobutyl rubber, especially chloro- or bromobutyl rubber (XIIR), nitrile rubber (NBR), hydrogenated nitrile rubber (H-NBR), carboxylated butadiene/acrylonitrile rubber (XNBR) or polychloroprene (CR) [CAS No. 9010-98-4], or mixtures of two or more of the aforementioned rubbers. The abbreviations between parentheses have been taken from DIN ISO 1629.

More preferably, the rubber which is to be crosslinked with elemental sulfur and is used for the rubber part in the inventive composite is at least one rubber from the group of natural rubber (NR), ethylene-propylene-diene rubber (EPDM), styrene/butadiene rubber (SBR), carboxylated butadiene/acrylonitrile rubber (XNBR), polychloroprene (CR), nitrile rubber (NBR) or polybutadiene (BR), or mixtures of two or more of the aforementioned rubbers.

Most preferably, the rubber which is to be crosslinked with elemental sulfur and is used for the rubber part in the inventive composite is at least one rubber from the group of natural rubber (NR), ethylene-propylene-diene rubber (EPDM), styrene/butadiene rubber (SBR), carboxylated butadiene/acrylonitrile rubber (XNBR) or polybutadiene (BR), or mixtures of two or more of the aforementioned rubbers.

In a very particularly preferred embodiment of the present invention, the rubber which is to be crosslinked with elemental sulfur and is used for the rubber part in the inventive composite is natural rubber (NR).

In a very particularly preferred embodiment of the present invention, the rubber which is to be crosslinked with elemental sulfur and is used for the rubber part in the inventive composite is ethylene-propylene-diene rubber (EPDM).

In a very particularly preferred embodiment of the present invention, the rubber which is to be crosslinked with elemental sulfur and is used for the rubber part in the inventive composite is styrene/butadiene rubber (SBR).

In a very particularly preferred embodiment of the present invention, the rubber which is to be crosslinked with elemental sulfur and is used for the rubber part in the inventive composite is polybutadiene (BR).

In a very particularly preferred embodiment of the present invention, the rubber which is to be crosslinked with elemental sulfur and is used for the rubber part in the inventive composite is polyisoprene (IR).

In a very particularly preferred embodiment of the present invention, the rubber which is to be crosslinked with elemental sulfur and is used for the rubber part in the inventive composite is butyl rubber (IIR).

In a very particularly preferred embodiment of the present invention, the rubber which is to be crosslinked with elemental sulfur and is used for the rubber part in the inventive composite is halobutyl rubber (XIIR).

In a very particularly preferred embodiment of the present invention, the rubber which is to be crosslinked with elemental sulfur and is used for the rubber part in the inventive composite is nitrite rubber (NBR).

In a very particularly preferred embodiment of the present invention, the rubber which is to be crosslinked with elemental sulfur and is used for the rubber part in the inventive composite is hydrogenated nitrile rubber (H-NBR).

In a very particularly preferred embodiment of the present invention, the rubber which is to be crosslinked with elemental sulfur and is used for the rubber part in the inventive composite is carboxylated butadiene/acrylonitrile rubber (XNBR).

In a very particularly preferred embodiment of the present invention, the rubber which is to be crosslinked with elemental sulfur and is used for the rubber part in the inventive composite is polychloroprene (CR).

The rubbers for use for the elastomer part may be in unfunctionalized form. In individual cases, the bond strength may be improved further when the rubber is functionalized, especially by introduction of hydroxyl groups, carboxyl groups or acid anhydride groups.

### Sulfur

According to the invention, the crosslinker/vulcanizer added to the rubber to be crosslinked for the elastomer part in the inventive composite is elemental sulfur [CAS No. 7704-34-9]. This is used in the form of either soluble or insoluble sulfur, preferably in the form of soluble sulfur.

Soluble sulfur is understood to mean the only form which is stable at normal temperatures, yellow cyclooctasulfur, also referred to as S8 sulfur or α-sulfur, which consists of typical rhombic crystals and has high solubility in carbon disulfide. For instance, at 25° C., 30 g of α-S dissolve in 100 g of CS₂ (see “Schwefel” [Sulfur] in the online Römpp Chemie Lexikon, August 2004 version, Georg Thieme Verlag Stuttgart).

Insoluble sulfur is understood to mean a sulfur polymorph which does not have a tendency to exude at the surface of rubber mixtures. This specific sulfur polymorph is insoluble to an extent of 60%-95% in carbon disulfide.

### Sulfur Donor

In an alternative preferred embodiment, in addition to elemental sulfur, at least one so-called sulfur donor is added to the rubber for the elastomer part of the inventive composite. These sulfur donors for additional use may or may not have accelerator action in relation to the vulcanization. Sulfur donors having no accelerator effect that are to be used with preference are dithiomorpholine (DTDM) [CAS No. 103-34-4] or caprolactam disulfide (CLD) [CAS No. 23847-08-7]. Sulfur donors having an accelerator effect that are to be used with preference are 2-(4-morpholinodithio)benzothiazole (MBSS) [CAS No. 102-77-2], tetramethylthiuram disulfide (TMTD) [CAS No. 137-26-8], tetraethylthiuram disulfide (TETD) [CAS No. 97-77-8] or dipentamethylenethiuram tetrasulfide (DPTT) [CAS No. 120-54-7] (J. Schnetger “Lexikon der Kautschuktechnik” 3rd edition, Hüthig Verlag Heidelberg, 2004, page 472 or F. Röthemeyer, F. Sommer “Kautschuktechnologie”, 2nd revised edition, Carl Hanser Verlag Munich Vienna, 2006, pages 309 to 310).

Elemental sulfur and sulfur donors that are optionally to be used additionally in preferred embodiments are used in the rubber mixture for use in accordance with the invention for the elastomer part in the inventive composite preferably in a total amount in the range from 0.1 to 15 parts by weight, more preferably 0.1-10 parts by weight, based on 100 parts by weight of the rubber for the elastomer component.

If two or more rubbers are used as elastomer component in the elastomer part of the inventive composite, the sum total of all the rubbers serves as the basis for the aforementioned figures in parts by weight. This also applies hereinafter to all the other amounts stated for the other components of an elastomer component for use in accordance with the invention for production of an inventive composite.

### Vulcanization Accelerator

In one embodiment which is preferred in accordance with the invention, at least one vulcanization accelerator suitable for sulfur vulcanization with elemental sulfur can be added as an additive to the rubber in the elastomer part of the inventive composite. Corresponding vulcanization accelerators are mentioned in J. Schnetger “Lexikon der Kautschuktechnik”, 3rd edition, Hüthig Verlag Heidelberg, 2004, pages 514-515, 537-539 and 586-589.

Vulcanization accelerators preferred in accordance with the invention are xanthogenates, dithiocarbamates, tetramethylthiuram disulfides, thiurams, thiazoles, thiourea derivatives, amine derivatives such as tetramines, sulfenimides, piperazines, amine carbamates, sulfenamides, dithiophosphoric acid derivatives, bisphenol derivatives or triazine derivatives.

Vulcanization accelerators particularly preferred in accordance with the invention are benzothiazyl-2-cyclohexylsulfenamide (CBS), benzothiazyl-2-tert-butylsulfenamide (TBBS), benzothiazyl-2-dicyclohexylsulfenamide (DCBS), 1,3-diethylthiourea (DETU), 2-mercaptobenzothiazole (MBT) and zinc salts thereof (ZMBT), copper dimethyldithiocarbamate (CDMC), benzothiazyl-2-sulfene morpholide (MBS), benzothiazyldicyclohexylsulfenamide (DCBS), 2-mercaptobenzothiazole disulfide (MBTS), dimethyldiphenylthiuram disulfide (MPTD), tetrabenzylthiuram disulfide (TBZTD), tetramethylthiuram monosulfide (TMTM), dipentamethylenethiuram tetrasulfide (DPTT), tetraisobutylthiuram disulfide (IBTD), tetraethylthiuram disulfide (TETD), tetramethylthiuram disulfide (TMTD), zinc N-dimethyldithiocarbamate (ZDMC), zinc N-diethyldithiocarbamate (ZDEC), zinc N-dibutyldithiocarbamate (ZDBC), zinc N-ethylphenyldithiocarbamate (ZEBC), zinc dibenzyldithiocarbamate (ZBEC), zinc diisobutyldithiocarbamate (ZDiBC), zinc N-pentamethylenedithiocarbamate (ZPMC), zinc N-ethylphenyldithiocarbamate (ZEPC), zinc 2-mercaptobenzothiazole (ZMBT), ethylenethiourea (ETU), tellurium diethyldithiocarbamate (TDEC), diethylthiourea (DETU), N,N-ethylenethiourea (ETU), diphenylthiourea (DPTU), triethyltrimethyltriamine (TTT); N-t-butyl-2-benzothiazolesulfenimide (TBSI); 1,1′-dithiobis(4-methylpiperazine); hexamethylenediamine carbamate (HMDAC); benzothiazyl-2-tert-butylsulfenamide (TOBS), N,N′-diethylthiocarbamyl-N′-cyclohexylsulfenamide (DETCS), N-oxydiethylenedithiocarbamyl-N′-oxydiethylenesulfenamide (OTOS), 4,4′-dihydroxydiphenyl sulfone (Bisphenol S), zinc isopropylxanthogenate (ZIX), selenium salts, tellurium salts, lead salts, copper salts and alkaline earth metal salts of dithiocarbamic acids; pentamethyleneammonium N-pentamethylenedithiocarbamate; dithiophosphoric acid derivatives; cyclohexylethylamine; dibutylamine; polyethylenepolyamines or polyethylenepolyimines, for example triethylenetetramine (TETA).

The vulcanization accelerators are preferably used in an amount in the range of 0.1 to 15 parts by weight, preferably 0.1-10 parts by weight, based on 100 parts by weight of the rubber for the elastomer component.

### Activator

In an embodiment preferred in accordance with the invention, an additive added to the rubber for the elastomer part of the inventive composite is zinc oxide [CAS No. 1314-13-2] and stearic acid [CAS No. 57-11-4] or zinc oxide and 2-ethylhexanoic acid [CAS No. 149-57-5] or zinc stearate [CAS No. 557-05-1]. Zinc oxide is used as an activator for the sulfur vulcanization. The selection of a suitable amount is possible for the person skilled in the art without any great difficulty. If the zinc oxide is used in a somewhat higher dosage, this leads to increased formation of monosulfidic bonds and hence to an improvement in aging resistance of the rubber component. In the case of use of zinc oxide, the inventive rubber component further comprises stearic acid (octadecanoic acid). This is known by the person skilled n the art to have a broad spectrum of action in rubber technology. For instance, one of its effects is that it leads to improved dispersion of the vulcanization accelerators in the elastomer component. In addition, complex formation occurs with zinc ions in the course of sulfur vulcanization. As an alternative to stearic acid, it is also possible to use 2-ethylhexanoic acid.

Preferably, zinc oxide is used in an amount of 0.5 to 15 parts by weight, preferably 1 to 7.5 parts by weight, especially preferably 1 to 5 parts by weight, based on 100 parts by weight of the rubber in the elastomer part.

Preferably, stearic acid or 2-ethylhexanoic acid is used in an amount of 0.1 to 7 parts by weight, preferably 0.25 to 7 parts by weight, preferably 0.5 to 5 parts by weight, based on 100 parts by weight of the rubber for the elastomer part.

Alternatively or else additionally to the combination of zinc oxide and stearic acid, in a preferred embodiment, zinc stearate may be used. In this case, typically an amount of 0.25 to 5 parts by weight, preferably 1 to 3 parts by weight, based in each case on 100 parts by weight of the rubber for the elastomer part in the inventive composite, is used. As an alternative to zinc stearate, it is also possible to use the zinc salt of 2-ethylhexanoic acid.

In an alternative preferred embodiment, as well as with elemental sulfur, the crosslinking in the elastomer part of the inventive composite can also be conducted as a mixed sulfur/peroxide crosslinking.

### Further Components

In addition, the elastomer component for the elastomer part in the inventive composite, in a preferred embodiment, comprises at least one further component from the group of fillers, masticating agents, plasticizers, processing active ingredients, aging. UV or ozone stabilizers, tackifiers, pigments or dyes, blowing agents, flame retardants, mold release agents, strengthening elements or bonding systems.

In the case of use of fillers in the elastomer component for the elastomer part in the inventive composite, preference is given to using at least one filler from the group of silica, carbon black, silicates, oxides or organic fillers.

“Silica” (Ullmann's Encyclopedia of Industrial Chemistry, VCH Verlagsgesellschaft mbH, D-69451 Weinheim, 1993, “Silica”, p. 635-645) is especially used in the form of fumed silica (ibid. p. 635-642) or of precipitated silica (ibid. 642-645), preference being given in accordance with the invention to precipitated silica [CAS No. 112926-00-8 or CAS No. 7631-86-9]. Precipitated silicas have a specific surface area of 5 to 1000 m2/g determined to BET, preferably a specific surface area of 20 to 400 m2/g. They are obtained by treatment of waterglass with inorganic acids, preference being given to using sulfuric acid. The silicas may optionally also be in the form of mixed oxides with other metal oxides, such as oxides of Al, Mg, Ca, Ba, Zn, Zr, Tl. Preference is given in accordance with the invention to using silicas having specific surface areas in the range from 5 to 1000 m²/g, more preferably in the range from 20 to 400 m²/g, determined in each case to BET.

The carbon blacks [CAS No. 1333-86-4] for use in one embodiment as fillers in the elastomer component for the elastomer part in the inventive composite are likewise known to those skilled in the art (see “carbon” or “carbon black” entries in Ullmann's Encyclopedia of industrial Chemistry, VCH Verlagsgesellscaft mbH, D-69451 Weinhelm, 1993, vol. A 5, p. 95-158). They are preferably produced by the gas black, furnace black, lamp black or thermal black process and are classified according to the new ASTM nomenclature (ASTM D 1765 and D 2516) as N 110, N 115, N 121, N 125, N 212, N 220, N 231, N 234, N 242, N 293, N 299, S 315, N 326, N 330, N 332, N 339, N 343, N 347, N 351, N 375, N 472, N 539, N 550, N 582, N 630, N 642, N 650, N 660, N 683, N 754, N 762, N 765, N 772, N 774, N 787, N 907, N 908, N 990, N 991 S 3 etc. Any carbon blacks for use as filler preferably have BET surface areas in the range from 5 to 200 m²/g.

Preferred further fillers which may be used in the elastomer component for the elastomer part in the inventive composite are those from the group of the synthetic silicates, especially aluminum silicate, the alkaline earth metal silicates, especially magnesium silicate or calcium silicate having BET surface areas in the range from 20 to 400 m²/g and primary particle diameters in the range from 5 to 400 nm, natural silicates such as kaolin, kieselguhr and other naturally occurring silicas, the metal oxides, especially aluminum oxide, magnesium oxide, calcium oxide, the metal carbonates, especially calcium carbonate, magnesium carbonate, zinc carbonate, the metal sulfates, especially calcium sulfate, barium sulfate, the metal hydroxides, especially aluminum hydroxide or magnesium hydroxide, the glass fibers or glass fiber products (bars, strands or glass microbeads), the thermoplastics, especially polyamide, polyester, aramid, polycarbonate, syndiotactic 1,2-polybutadiene or trans-1,4-polybutadiene, and cellulose, cellulose derivatives or starch.

In the case of use of additional masticating agents in the elastomer component for the elastomer part in the inventive composite, preference is given to using at least one masticating agent from the group of thiophenols, thiophenol zinc salts, substituted aromatic disulfides, peroxides, thiocarboxylic acid derivatives, nitroso compounds, hydrazine derivatives, Porofors (blowing agents) or metal complexes, especially iron hemiporphyrazine, iron phthalocyanine, iron acetonylacetate or the zinc salt thereof (J. Schnetger “Lexikon der Kautschuktechnik” 3rd edition, Hüthig Verlag Heidelberg, 2004, pages 1 to 2). The way in which the masticating agents work is described in EP 0 603 611 A1.

In the case of use of additional plasticizers in the elastomer component for the elastomer part in the inventive composite, preference is given to using at least one plasticizer from the group of paraffinic mineral oils, naphthenic mineral oils, aromatic mineral oils, aliphatic esters, aromatic esters, polyesters, phosphates, ethers, thioethers, natural fats or natural oils (F. Röthemeyer, F. Sommer “Kautschuktechnologie”, 2nd revised edition, Carl Hanser Verlag Munich Vienna, 2006, pages 329 to 337).

In the case of use of additional processing active ingredients in the elastomer component for the elastomer part in the inventive composite, preference is given to using at least one processing active ingredient from the group of fatty acids, fatty acid derivatives, fatty acid esters, fatty alcohols or factice (F. Röthemeyer, F. Sommer “Kautschuktechnologie”, 2nd revised edition, Carl Hanser Verlag Munich Vienna, 2006, pages 337 to 338). Factice, also known as oil rubber, is a rubber-like material which arises through crosslinking of unsaturated mineral oils and vegetable oils, in Europe particularly of rapeseed oil (colza oil) and castor oil, and in America additionally of soya oil. In this regard, see also: http://de.wikipedia.org/wiki/Faktis.

In the case of use of additional aging, UV and ozone stabilizers in the elastomer component, preference is given to using at least one aging, UV and ozone stabilizer from the group of UV stabilizers, especially carbon black—unless it is already being used as a filler—or titanium dioxide, antiozonant waxes, additives that break down hydroperoxides (tris(nonylphenyl) phosphite), heavy metal stabilizers, substituted phenols, diarylamines, substituted p-phenylenediamines, heterocyclic mercapto compounds, paraffin waxes, microcrystalline waxes and para-phenylenediamines (F. Röthemeyer, F. Sommer “Kautschuktechnologie”, 2nd revised edition, Carl Hanser Verlag Munich Vienna, 2006, pages 338 to 344).

In the case of use of additional tackifier resins in the elastomer component of the elastomer part in the inventive composite, preference is given to using at least one tackifier resin from the group of natural resin, hydrocarbon resin and phenol resin (F. Röthemeyer, F. Sommer “Kautschuktechnologie”, 2nd revised edition, Carl Hanser Verlag Munich Vienna, 2006, pages 345 to 346).

In the case of use of additional pigments and dyes in the elastomer component of the elastomer part in the inventive composite, preference is given to using at least one pigment or dye from the group of titanium dioxide—unless it is already being used as a UV stabilizer—lithopone, zinc oxide, iron oxide, ultramarine blue, chromium oxide, antimony sulfide and organic dyes (F. Röthemeyer, F. Sommer “Kautschuktechnologie”, 2nd revised edition, Carl Hanser Verlag Munich Vienna, 2006, page 345).

In the case of use of additional blowing agents in the elastomer component of the elastomer part in the inventive composite, preference is given to using at least one blowing agent from the group of benzenesulfohydrazide, dinitrosopentamethylenetetramine and azodicarbonamide (F. Röthemeyer, F. Sommer “Kautschuktechnologie”, 2nd revised edition, Carl Hanser Verlag Munich Vienna, 2006, page 346).

In the case of use of additional flame retardants in the elastomer component of the elastomer part in the inventive composite, preference is given to using at least one flame retardant from the group of aluminum oxide hydrate, halogenated flame retardants and phosphorus flame retardants (F. Röthemeyer, F. Sommer “Kautschuktechnologie”, 2nd revised edition, Cad Hanser Verlag Munich Vienna, 2006, page 346).

In the case of use of mold release agents in the elastomer component of the elastomer part in the inventive composite, preference is given to using at least one mold release agent from the group of saturated and partly unsaturated fatty acids and oleic acids and derivatives thereof, especially fatty acid esters, fatty acid salts, fatty alcohols, fatty acid amides. In the case of application of the mold release agents to the mold surface, it is possible with preference to use products based on low molecular weight silicone compounds, products based on fluoropolymers and products based on phenol resins.

In the case of use of strengthening elements (fibers) in the elastomer component of the elastomer part in the inventive composite for strengthening the vulcanizates, preference is given to using at least one strengthening element in the form of fibers based on glass, according to U.S. Pat. No. 4,826,721, or cord, woven fabric, fibers of aliphatic or aromatic polyamides (Nylon®, Aramid®), of polyesters or of natural fiber products. It is possible to use either staple fibers or continuous fibers (J. Schnetger “Lexikon der Kautschuktechnik” 3rd edition, Hüthig Verlag Heidelberg, 2004, pages 498 and 528). An illustrative list of strengthening elements customary in the rubber industry can be found, for example, in F. RÖthemeyer, F. Sommer “Kautschuktechnologie”, 2nd revised edition, Carl Hanser Verlag Munich Vienna, 2006, pages 823 to 827.

Manifestations of the elastomer component of the elastomer part in the Inventive composite that are included within the scope of the invention are foamed vulcanizates, cellular rubber or else foam rubber (J. Schnetger “Lexikon der Kautschuktechnik” 3rd edition, Hüthig Verlag Heidelberg, 2004, pages 322-323 and 618). In a preferred embodiment, foamed vulcanizates are produced with the aid of blowing agents.

Preferably, the elastomer component of the elastomer part in the inventive composite which is to be crosslinked with sulfur and is to be used for the inventive shaping method is processed from at least one rubber, sulfur and optionally further constituents by means of the operation of what is called mixture processing with the aid of an internal mixer or a roll mil to give a vulcanizable rubber mixture, and hence prepared for the actual shaping method. In this mixture processing operation, the constituents of the rubber mixtures are mixed intimately with one another. In principle, the mixture can be produced batchwise by means of an internal mixer or roll mill, or continuously by means of extruders (J. Schnetger “Lexikon der Kautschuktechnik” 3rd edition, Hüthig Verlag Heidelberg, 2004, pages 275 and 315 to 318).

### Polyamide Component

The polyamide for use for the polyamide component of the inventive composite is preferably prepared from a combination of diamine and dicarboxylic acid, from an ω-aminocarboxylic acid or from a lactam. Polyamides for use with preference are PA6, PA6 6, PA6 10 [CAS No. 9011-52-3], PA8 8, PA6 12 [CAS No. 26098-55-5], PA8 10, PA10 8, PA9, PA6 13, PA6 14, PA8 12, PA10 10, PA10, PA8 14, PA14 8, PA10 12, PA11 [CAS No. 25035-04-5], PA10 14, PA12 12 or PA12 [CAS No. 24937-16-4]. The nomenclature of the polyamides used in the context of the present application corresponds to the international standard, the first number(s) denoting the number of carbon atoms in the starting diamine and the last number(s) denoting the number of carbon atoms in the dicarboxylic acid. If only one number is stated, as in the case of PA6, this means that the starting material was an α,ω-aminocarboxylic acid or the lactam derived therefrom, i.e. ε-caprolactam in the case of PA 6; for further information, reference is made to H. Domininghaus, Die Kunststoffe und ihre Eigenschaften, pages 272 ff., VDI-Verlag, 1976. More preferably in accordance with the invention, PA [CAS No. 25038-54-4] or PA6 6 [CAS No. 32131-17-2], especially PA6, is used for the polyamide molding compound for use in the two-component Injection molding process for production of the inventive composite. The preparation of the polyamides is prior art. It will be appreciated that it is also possible to use copolyamides based on the abovementioned polyamides.

A multitude of procedures for preparation of polyamides have become known, with use, depending on the desired end product, of different monomer units, different chain transfer agents to establish a desired molecular weight, or else monomers with reactive groups for aftertreatments intended at a later stage. The methods of industrial relevance for preparation of the polyamides for use in accordance with the invention proceed preferably via polycondensation in the melt or via polyaddition of appropriate lactams. The polyaddition reactions of lactams include hydrolytic, alkaline, activated anionic and cationic lactam polymerization. The preparation of polyamides by thermal polycondensation and by lactam polymerization is known to those skilled in the art; see, inter alia, Nylon Plastics Handbook, Hanser-Verlag Munich 1995, pages 17-27 and Kunststoff-Handbuch [Plastics Handbook] 3/4, Polyamide [Polyamides], Carl Hanser Verlag, Munich 1998, pages 22-57.

Polyamides for use with preference in accordance with the invention are semicrystalline aliphatic polyamides which can be prepared proceeding from diamines and dicarboxylic acids and/or lactams having at least 5 ring members or corresponding amino acids. According to DE 10 2011 084 519 A1, semicrystalline polyamides have an enthalpy of fusion of more than 25 J/g, measured by the DSC method to ISO 11357 in the 2nd heating operation and integration of the melt peak. This distinguishes them from the semicrystalline polyamides having an enthalpy of fusion in the range from 4 to 25 J/g, measured by the DSC method to ISO 11357 in the 2nd heating operation and integration of the melt peak, and from the amorphous polyamides having an enthalpy of fusion of less than 4 J/g, measured by the DSC method to ISO 11357 in the 2nd heating operation and integration of the melt peak.

Useful reactants for preparation of the polyamide-based part of the inventive composite are preferably aliphatic and/or aromatic dicarboxylic acids, more preferably adipic acid, 2,2,4-trimethyladipic acid, 2,4,4-trimethyladipic acid, azelaic acid, sebacic acid, isophthalic acid, terephthalic acid, aliphatic and/or aromatic diamines, more preferably tetramethylenediamine, pentamethylenediamine, hexamethylenediamine, nonane-1,9-diamine, 2,2,4- and 2,4,4-trimethylhexamethylenediamine, the isomeric diaminodicyclohexylmethanes, diaminodicyclohexylpropanes, bis(aminomethyl)cyclohexane, phenylenediamines, xylylenediamines, aminocarboxylic acids, especially aminocaproic acid, or the corresponding lactams. Copolyamides of a plurality of the monomers mentioned are included.

Particular preference is given to nylon-6 (PA6), nylon-6,6 (PA6 6) or caprolactam as comonomer-containing copolyamides, very particular preference to random semicrystalline aliphatic copolyamides, especially PA 6/6 6.

ε-Caprolactam [CAS No. 105-60-2] is preferably used for preparation of polyamide inter alia. Cyclohexanone oxime is first prepared from cyclohexanone by reaction with the hydrogensulfate or the hydrochloride of hydroxylamine. This is converted to ε-caprolactam by a Beckmann rearrangement.

Hexamethylenediamine adipate [CAS No. 3323-53-3] is the reaction product of adipic acid and hexamethylenediamine. One of its uses is as an intermediate in the preparation of nylon-6,6. The trivial name AH salt derives from the initial letters of the starting substances. Semicrystalline PA6 and/or PA 6 6 for use in accordance with the invention is obtainable, for example, under the Durethan® name from Lanxess Deutschland GmbH, Cologne, Germany.

It will be appreciated that it is also possible to use mixtures of these polyamides, in which case the mixing ratio is as desired. It is also possible for proportions of recycled polyamide molding compositions and/or fiber recyclates to be present in the polyamide component.

It is likewise also possible to use mixtures of different polyamides, assuming sufficient compatibility. Compatible polyamide combinations are known to those skilled in the art. Polyamide combinations for use with preference are PA6/PA6 6, PA12/PA10 12, PA12/12 12, PA6 12/PA12, PA6 13/PA12, PA10 14/PA12 or PA6 10/PA12 and corresponding combinations with PA11, more preferably PA6/PA6 6. In the case of doubt, compatible combinations can be ascertained by routine tests.

Instead of aliphatic polyamides, it is advantageously also possible to use a semiaromatic polyamide wherein the dicarboxylic acid component originates to an extent of 5 to 100 mol % from aromatic dicarboxylic acid having 8 to 22 carbon atoms and which preferably has a crystallite melting point Tₘ to ISO 11357-3 of at least 250° C., more preferably of at least 260° C. and especially preferably of at least 270° C. Polyamides of this kind are typically referred to by the additional label T (T=semiaromatic). They are preparable from a combination of diamine and dicarboxylic acid, optionally with addition of an ω-aminocarboxylic acid or the corresponding lactam. Suitable types are preferably PA6 6/6T, PA6/6T, PA6T/MPMDT (MPMD stands for 2-methylpentamethylenediamine), PA9T, PA10T, PA11T, PA12T, PA14T and copolycondensates of these latter types with an aliphatic diamine and an aliphatic dicarboxylic acid or with an ω-aminocarboxylic acid or a lactam. The semiaromatic polyamide can also be used in the form of a blend with another, preferably aliphatic, polyamide, more preferably with PA6, PA6 6, PA11 or PA12.

Another suitable polyamide class is that of transparent polyamides; in most cases, these are amorphous, but may also be microcrystalline. They can be used either on their own or in a mixture with aliphatic and/or semiaromatic polyamides, preferably with PA6, PA6 6, PA11 or PA12. For the achievement of good adhesion, the degree of transparency is immaterial; what is crucial here is that the glass transition point T_{g}, measured to ISO 11357-3, is at least 110° C., preferably at least 120° C., more preferably at least 130° C. and more preferably at least 140° C. Preferred transparent polyamides are:
the polyamide formed from 1,12-dodecanedioic acid and 4,4′-diaminodicyclohexylmethane (PAPACM12), especially proceeding from a 4,4′-diaminodicyclohexylmethane having a trans,trans isomer content of 35% to 65%;
the polyamide formed from terephthalic acid and/or isophthalic acid and the isomer mixture of 2,2,4- and 2,4,4-trimethylhexamethylenediamine,
the polyamide formed from isophthalic acid and 1,6-hexamethylenediamine,
the copolyamide formed from a mixture of terephthalic acid/isophthalic acid and 1,6-hexamethylenediamine, optionally in a mixture with 4,4′-diaminodicyclohexylmethane,
the copolyamide of terephthalic acid and/or isophthalic acid, 3,3′-dimethyl-4,4′-diaminodicyclohexylmethane and laurolactam or caprolactam,
the (co)polyamide formed from 1,12-dodecanedioic acid or sebacic acid, 3,3′-dimethyl-4,4′-diaminodicyclohexylmethane and optionally laurolactam or caprolactam,
the copolyamide formed from isophthalic acid, 4,4′-diaminodicyclohexylmethane and laurolactam or caprolactam,
the polyamide formed from 1,12-dodecanedioic acid and 4,4′-diaminodicyclohexylmethane (with low trans,trans isomer content).
the copolyamide formed from terephthalic acid and/or isophthalic acid and an alkyl-substituted bis(4-aminocyclohexyl)methane homologue, optionally in a mixture with hexamethylenediamine,
the copolyamide formed from bis(4-amino-3-methyl-5-ethyl-cyclohexyl)methane, optionally together with a further diamine, and isophthalic acid, optionally together with a further dicarboxylic acid,
the copolyamide formed from a mixture of m-xylylenediamine and a further diamine, e.g. hexamethylenediamine, and isophthalic acid, optionally together with a further dicarboxylic acid, for example terephthalic acid and/or 2,6-naphthalenedicarboxylic acid,
the copolyamide formed from a mixture of bis(4-aminocyclohexyl)methane and bis(4-amino-3-methylcyclohexyl)methane, and aliphatic dicarboxylic acids having 8 to 14 carbon atoms, and also
polyamides or copolyamides formed from a mixture containing 1,14-tetradecanedioic acid and an aromatic arylaliphatic or cycloaliphatic diamine.

These examples can be varied very substantially by addition of further components, preferably caprolactam, laurolactam or diamine/dicarboxylic acid combinations, or by partial or full replacement of starting components with other components.

Lactams or ω-aminocarboxylic acids which are used as polyamide-forming monomers contain 4 to 19 and especially 6 to 12 carbon atoms. Particular preference is given to using ε-caprolactam, ε-aminocaproic acid, caprylolactam, ω-aminocaprylic acid, laurolactam, ω-aminododecanoic acid and/or ω-aminoundecanoic acid.

Combinations of diamine and dicarboxylic acid are, for example, hexamethylenediamine/adipic acid, hexamethylenediamine/dodecanedioic acid, octamethylenediamine/sebacic acid, decamethylenediamine/sebacic acid, decamethylenediamine/dodecanedioic acid, dodecamethylenediamine/dodecanedioic acid and dodecamethylenediamine/naphthalene-2,6-dicarboxylic acid. In addition, it is also possible to use all other combinations, especially decamethylenediamine/dodecanedioic acid/terephthalic acid, hexamethylenediamine/adipic acid/terephthalic acid, hexamethylenediamine/adipic acid/caprolactam, decamethylenediamine/dodecanedioic acid/ω-aminoundecanoic acid, decamethylenediamine/dodecanedioic acid/laurolactam, decamethylenediamine/terephthalic acid/laurolactam or dodecamethylenediamine/naphthalene-2,6-dicarboxylic acid/laurolactam.

Polyamide molding compositions in the context of this invention are formulations of polyamides for the production of the polyamide component in the inventive composite, which are made in order to improve the processing properties or to modify the use properties. The polyamide-based component for use in accordance with the invention for the composite is formulated by mixing the polyamide, polyoctenamer and polybutadiene components for use as reactants in at least one mixing apparatus. This affords molding compounds as intermediate products. These molding compounds—often also referred to as thermoplastic molding compounds—may either consist exclusively of the polyamide, polyoctenamer and polybutadiene components, or else may comprise further components in addition to these components. In the latter case, at least one of the polyamide, polyoctenamer and polybutadiene components should be varied within the scope of the ranges specified such that the sum total of all parts by weight in the polyamide-based component is always 100.

In a preferred embodiment, these polyamide molding compounds, in addition to the polyamide, the polyoctenamer and the polybutadiene, comprise at least one of the following additives:
(I) other polymers, for instance impact modifiers, ABS (ABS=acrylonitrile-butadiene-styrene) or polyphenylene ethers. It should be ensured here that no phase inversion takes place, meaning that the matrix of the molding composition is formed from polyamide, or that at least an interpenetrating network is present. The person skilled in the art is aware that phase morphology depends primarily on the proportions by volume of the individual polymers and the melt viscosities. If the other polymer has a much higher melt viscosity than the polyamide, the polyamide forms the matrix even when it is present to an extent of less than 50 percent by volume of the thermoplastic fraction, for example to an extent of about 40 percent by volume. This is relevant especially in the case of blends with polyphenylene ether;
(II) fibrous reinforces, especially glass fibers having a round or flat cross section, carbon fibers, aramid fibers, fibers of stainless steel or potassium titanate whiskers;
(III) fillers, especially talc, mica, silicate, quartz, zirconium dioxide, aluminum oxide, iron oxides, zinc sulfide, graphite, molybdenum disulfide, titanium dioxide, wollastonite, kaolin, amorphous silicas, magnesium carbonate, chalk, lime, feldspar, barium sulfate, conductive black, graphite fibrils, solid glass beads, hollow glass beads or ground glass;
(IV) plasticizers, especially esters of p-hydroxybenzoic acid having 2 to 20 carbon atoms in the alcohol component or amides of arylsulfonic acids having 2 to 12 carbon atoms in the amine component, preferably amides of benzenesulfonic acid;
(V) pigments and/or dyes, especially carbon black, iron oxide, zinc sulfide, ultramarine, nigrosin, pearlescent pigments or metal flakes;
(VI) flame retardants, especially antimony trioxide, hexabromocyclododecane, tetrabromobisphenol, borates, red phosphorus, magnesium hydroxide, aluminum hydroxide, melamine cyanurate and condensation products thereof such as melam, melem, melon, melamine compounds, especially melamine pyrophosphate or melamine polyphosphate, ammonium polyphosphate and organophosphorus compounds or salts thereof, especially resorcinol diphenylphosphate, phosphonic esters or metal phosphinates;
(VII) processing aids, especially paraffins, fatty alcohols, fatty acid amides, fatty acid esters, hydrolysed fatty acids, paraffin waxes, montanates, montan waxes or polysiloxanes; and
(VIII) stabilizers, especially copper salts, molybdenum salts, copper complexes, phosphites, sterically hindered phenols, secondary amines, UV absorbers or HALS stabilizers.

The mixture of polyoctenamer and polybutadiene for use in accordance with the invention is incorporated in various ways into the polyamide or into the polyamide molding compound for the at least one polyamide part of the inventive composite part. In a preferred embodiment, the polyoctenamer and the polybutadiene, also referred to as masterbatch of polyoctenamer and polybutadiene, are added to the polyamide during the compounding of the polyamide molding compounds together with the other added substances, or added as a masterbatch to the polyamide during the compounding, or supplied in the injection molding operation as a mixture with the polyamide molding compound, which is preferably used in pellet form, via a metering funnel to the injection molding unit.

In an alternative preferred embodiment, the polyoctenamer/polybutadiene-containing polyamide molding compound is produced in the form of a pellet mixture (dry mixture, dry blend; see Die Kunststoffe-Chemie, Physik, Technologie, edited by B. Carlowitz, Carl Hanser Verlag Munich Vienna, 1990, p. 266) from at least one polyamide molding compound comprising at least one polyoctenamer and/or at least one polybutadiene, and a polyamide molding compound comprising neither polyoctenamer nor polybutadiene, and hence a polyamide molding compound having an adjusted polyoctenamer/polybutadiene concentration is obtained.

In a further alternative preferred embodiment, at least one solution comprising at least one polyoctenamer and/or at least one polybutadiene in a suitable solvent is mixed with a solution of polyamide in a suitable solvent. If, proceeding from this solution, the solvents are distilled off, the polyoctenamer/polyamide-containing polyamide molding compound is obtained after drying.

In a further alternative preferred embodiment, the addition of polyoctenamer and polybutadiene, alternatively also in the form of a masterbatch of polyoctenamer and polybutadiene, in the injection molding operation is effected as a mixture with the polyamide molding compound, which is usually used in pellet form, via a metering funnel of the molding system.

More preferably in accordance with the invention, the addition of polyoctenamer and polybutadiene, alternatively also as a masterbatch of polyoctenamer and polybutadiene, to the polyamide is effected via a metering apparatus, for solid substances preferably by a metering funnel and for liquid substances preferably via a metering pump, during the compounding together with the standard admixtures.

### Shaping Method

The inventive composite can be produced in one or two stages by at least one shaping method from the group of extrusion, flat film extrusion, film blowing, extrusion blow molding, coextrusion, calendaring, casting, compression methods, Injection compression methods, transfer compression methods, transfer injection compression methods or injection molding or the special methods thereof, especially gas injection technology, preferably by multicomponent injection molding, more preferably by 2-component injection molding, also referred to as 2K injection molding.

The shaping method of extrusion is understood in accordance with the invention to mean the continuous production of semifinished polymer products, especially films, sheets, tubes or profiles. In the extrusion method, what is called the extruder, consisting of a screw and barrel, forces the polymer composition continuously through a mold under pressure. In practice, single-screw and twin-screw extruders or special designs are used. The choice of mold establishes the desired cross-sectional geometry of the extrudate (Ullmann's Encyclopedia of Industrial Chemistry, 7th edition, vol. 28, Plastics Processing, Wiley-VCH Verlag, Weinhelm, 2011, p. 169 to 177).

In the extrusion of rubber mixtures, the pass through the mold is followed by the vulcanization. A distinction is made here between vulcanization processes under pressure and ambient pressure vulcanization processes (F. Röthemeyer, F. Sommer “Kautschuktechnologie”, 2nd revised edition, Carl Hanser Verlag Munich Vienna, 2006, pages 597 to 727). In the shaping method of coextrusion, polyamide molding compounds and rubber compositions are combined upstream of the shaping orifice, in order to obtain a composite of polyamide and elastomer after the vulcanization of the extrudate (Ullmann's Encyclopedia of Industrial Chemistry, 7th edition, vol. 28, Plastics Processing, Wiley-VCH Verlag, Weinheim, 2011, p. 177). The coextrusion of polyamide molding compound and rubber compound can also be effected sequentially, i.e. with one downstream of the other (F. Röthemeyer, F. Sommer “Kautschuktechnologie”, 2nd revised edition, Carl Hanser Verlag Munich Vienna, 2006, pages 852 to 853). In the contacting and vulcanization to completion after the two-stage extrusion process, a profile of a polyamide molding compound produced in a first stage, for example a tube, is ensheathed with a rubber compound and vulcanized to completion, optionally under pressure. The procedure is analogous with sheets formed from polyamide molding compounds (F. Röthemeyer, F. Sommer “Kautschuktechnologie”, 2nd revised edition, Carl Hanser Verlag Munich Vienna, 2006, pages 977 to 978).

With the shaping methods of flat film extrusion, film blowing, extrusion blow molding, coextrusion, calendaring or casting, it is possible to obtain films or laminates (Die Kunststoffe-Chemie, Physik, Technologie, edited by B. Carlowitz, Carl Hanser Verlag Munich Vienna, 1990, p. 422 to 480). Polyamides and rubber mixtures that are to be crosslinked with sulfur can be combined by these methods to give multilayer laminates and multilayer films. Optionally, the production of the film is followed by vulcanization of the rubber component to completion. Coextruded multilayer films are of great significance for packaging technology.

In the compression molding process, blanks are first produced from the unvulcanized rubber mixture via extrusion with subsequent punching or cutting. The blanks are placed into the cavities of a mold preheated to vulcanization temperature. With application of pressure and heat, shaping is effected to the desired molding geometry, and vulcanization sets in (F. Röthemeyer, F. Sommer “Kautschuktechnologie”, 2nd revised edition, Carl Hanser Verlag Munich Vienna, 2006, pages 729 to 738). The procedure is analogous with the compression molding of thermoplastics. Here, the mold is cooled until demolding (Ullmann's Encyclopedia of Industrial Chemistry, 7th edition, vol. 28, Plastics Processing, Wiley-VCH Verlag, Weinheim, 2011, p. 167).

Injection compression molding is a special method of injection molding for production of high-accuracy polymer parts without warpage. This involves injecting the polymer melt into the mold only with reduced closure force, which leads to slight opening of the halves of the mold. For the filling of the entire mold cavity, the full closure force is applied and hence the molding is finally demolded (Ullmann's Encyclopedia of Industrial Chemistry, 7th edition, vol. 28, Plastics Processing, Wiley-VCH Verlag, Weinheim, 2011, p. 187). In the injection compression molding of rubbers, the procedure is analogous, by injecting the rubber mixture into a mold heated to vulcanization temperature. With the closure of the mold, shaping and vulcanization are effected (F. Röthemeyer, F. Sommer “Kautschuktechnologie”, 2nd revised edition, Carl Hanser Verlag Munich Vienna, 2006, pages 738 to 739).

With regard to the transfer compression method and transfer injection compression method, see F. Röthemeyer, F. Sommer “Kautschuktechnologie”, 2nd revised edition, Carl Hanser Verlag Munich Vienna, 2006, chapters 12.3 and 12.4, pages 740 to 753, and chapter 12.5, pages 753 to 755.

Injection molding is a molding method which is used principally in polymer processing. This method can be used in an economically viable manner to produce directly usable moldings in large numbers without further processing. For this purpose, an injection molding machine is used to plastify the particular polymeric material in an injection molding unit and inject it into an injection mold. The cavity of the mold determines the shape of the finished part. Nowadays, parts from a few tenths of a gram to the upper kilogram range are producible by injection molding (Ullmann's Encyclopedia of Industrial Chemistry, 7th edition, vol. 28, Plastics Processing, Wiley-VCH Verlag, Weinhelm, 2011, p. 181 to 189).

In the case of multicomponent injection molding, several components are combined in the injection molding process to form a composite part. In the case of 2-component injection molding, two components are combined in the injection molding process to form a composite or composite part. Preference is given in accordance with the invention to combining a polyamide component and an elastomer component in the 2-component injection molding process to form a composite. The 2-component injection molding process can be conducted either in a one-stage process or in a two-stage process (F. Johannaber, W. Michael, Handbuch Spritzgieβen [Injection Molding Handbook], 2nd edition, Carl Hanser Verlag Munich, 2004, pages 506 to 523; Handbuch Kunststoff-Verbindungstechnik, edited by G. W. Ehrenstein, Carl Hanser Verlag Munich Vienna, 1990, pages 517 to 540).

In the two-stage process, the polyoctenamer/polybutadiene-containing polyamide molding compound for use in accordance with the invention is first used to produce the stiff thermoplastic molding, especially by one of the abovementioned processing methods, preferably by injection molding. This thermoplastic molding can be stored if required.

In a further step, the polyamide molding is contacted with the elastomer component by means of one of the abovementioned processing methods, preferably by injection molding, and exposed to the vulcanization conditions for the rubber.

Manufacturing can also be effected with a machine (one-stage process) which preferably has a swivel plate or turntable, and/or corresponding mold technology, preferably by means of slide vanes, which open up regions of the cavity for the second component with a time delay. When a machine having a swivel plate, a turntable or a mold having one or more slide vanes is used, a preform is typically produced in a first cycle from the polyamide component in a cavity of the mold, the first station. After a rotational movement of the mold, or by means of transfer technology, the preform is introduced into a second, geometrically altered final injection molding station (for example by means of the turning technique by a rotation by 180° or 120° in three-cavity molds, or by means of a slide vane shut-off technique, called the core back method) and, in a second cycle, the rubber mixture for the elastomer part, obtainable from rubber which is to be vulcanized or crosslinked with elemental sulfur, is injected. After demolding stability has been attained, the elastomer component can be demolded.

The melt temperatures of the polyamide for use as thermoplastic component in accordance with the invention are preferably in the range from 180 to 340° C., more preferably in the range from 200 to 300° C. The mold temperatures of the thermoplastic temperature control regions are preferably in the range from 20 to 200° C., more preferably in the range from 60 to 180° C. Preferred melt temperatures of the rubber mixture for the elastomer part, obtainable from rubber which is to be vulcanized or crosslinked with elemental sulfur, in the plastifying barrel are in the range from 20 to 150° C., preferably in the range from 80 to 100° C. Preferred vulcanization temperatures of the elastomer component are in the range from 120 to 220° C., preferably in the range from 140 to 200° C. In a preferred embodiment, the demolding of the elastomer component from the mold cavity is followed by a heat treatment. In the physical sense, heat treatment means that a solid is heated to a temperature below the melting temperature. This is done over a prolonged period of a few minutes up to a few days. The increased mobility of the atoms can thus balance out structural defects and improve the short- and long-range crystal structure. In this way, the process of melting and (extremely) slow cooling to establish the crystal structure can be avoided. A heat treatment in the context of the present invention is preferably effected at a temperature in the range from 120 to 220° C., preferably at a temperature in the range from 140 to 200° C.

These values are dependent to a considerable degree on the component geometry (for example the thickness and the length of the flow path), the type and position of the gate design (e.g. hot or cold runner), and on the specific material characteristics. The hold pressure phase is preferably within ranges from 0 to 3000 bar with hold pressure times of 0 seconds until the opening of the mold.

In an alternative preferred embodiment of the present invention, the inventive composite is manufactured from a polyamide part and an elastomer part in what is called inverse 2-component Injection molding (2K injection molding), i.e. In the sequence of first the soft component, then the hard component, the polyamide part in turn being manufactured from the polyoctenamer- and polybutadiene-containing polyamide molding compound for use in accordance with the invention and the elastomer part from the rubber to be crosslinked in the presence of free sulfur.

In inverse 2K injection molding, the rubber mixture for the elastomer part, obtainable from rubber which is to be vulcanized or crosslinked with elemental sulfur, Is thus first injection-molded and vulcanized, then the polyoctenamer- and polybutadiene-containing polyamide molding compound for use in accordance with the invention is applied by injection molding. Exactly as in the (conventional) 2K injection molding process, manufacturing can be effected in a machine (one-stage process) which preferably has a swivel plate or turntable, and/or corresponding mold technology, preferably by means of slide vanes, which open up regions of the cavity for the second component with a time delay. The corresponding injection molding parameters can be adopted from the (conventional) 2K injection molding process (barrel temperatures, mold temperatures, vulcanization times, hold pressure, hold pressure times, etc.). If the elastomer component is not vulcanized to completion, but only partly vulcanized until dimensionally stable, and then the polyamide molding composition is applied by injection molding, an advantage of the inverse 2K injection molding process is experienced. This is because it is possible in this way to shorten the cycle time for the production of the overall composite. Since the cycle time for the production of the polyamide component is typically very much shorter than that of the elastomer component, it is surprisingly possible by this preferred process to reduce the cycle time for the production of the entire composite to the cycle time for the production of the elastomer component. In a preferred embodiment, in inverse 2K injection molding too, the demolding of the composite from the mold cavity is followed by a heat treatment.

The process of injection molding of polyamide features melting (plastification) of the raw material, i.e. the inventive molding composition to be used, preferably in pellet form, in a heated cylindrical cavity, and injection thereof as an injection molding material under pressure into a temperature-controlled cavity. After the cooling (solidification) of the material, the Injection molding is demolded.

The injection molding process is broken down into the component steps of:

### 1. Plastification/melting

2. Injection phase (filling operation)
3. Hold pressure phase (owing to thermal contraction in the course of crystallization)

### 4. Demolding.

An injection molding machine to be used for this purpose consists of a closure unit, the injection unit, the drive and the control system. The closure unit includes fixed and movable platens for the mold, an end platen, and tie bars and drive for the movable mold platen (toggle joint or hydraulic closure unit).

An injection unit comprises the electrically heatable barrel, the drive for the screw (motor, gearbox) and, if necessary, the hydraulics for moving the screw and the injection unit. The task of the injection unit is to melt the powder or the pellets, to meter them, to inject them and to maintain the hold pressure (owing to contraction). The problem of the melt flowing backward within the screw (leakage flow) is solved by non-return valves.

In the injection mold, the incoming melt is then cooled, and hence the component, i.e. the product or molding, which is to be produced is produced. Two halves of the mold are always needed for this purpose. In injection molding, the following functional systems are distinguished:
runner system
shaping inserts
venting
machine casing and force absorber
demolding system and movement transmission
temperature control.

For the Injection molding of polyamides, see also Kunststoff-Handbuch 3/4, Polyamide, Carl Hanser Verlag, Munich 1998, pages 315-352.

The process of injection molding for production of vulcanized rubber moldings features plastification of the raw material, i.e. the rubber mixture to be crosslinked, in a heated cylindrical cavity, and injection thereof as an injection molding material under pressure into a cavity heated to vulcanization temperature. After the material has been vulcanized to completion, the injection molding is demolded. The cylinder and screws of the injection molding machine are designed in a manner known to those skilled in the art for rubber processing and the mold is heatable to vulcanization temperature. The vulcanization times for the rubber component are guided not only by the rubber mixture but also by the vulcanization temperatures and by the geometry of the rubber component to be manufactured. They are preferably between 15 s and 15 min; lower temperatures and thicker rubber parts entail longer vulcanization times (F. Röthemeyer, F. Sommer “Kautschuktechnologie”, 2nd revised edition, Carl Hanser Verlag Munich Vienna, 2006, pages 755 to 815).

In the case of the optional additional use of external demolding aids, care should be taken that they do not get into the interface layer of the tools, since they can impair bond strength. Useful demolding agents (also referred to as lubricants or mold release agents) for optional use in accordance with the invention preferably include saturated and partly unsaturated fatty acids and oleic acids and derivatives thereof, especially fatty acid esters, fatty acid salts, fatty alcohols, fatty acid amides, which are preferably used as a mixture constituent, and also additionally products applicable to the mold surface, especially products based on low molecular weight silicone compounds, products based on fluoropolymers and products based on phenol resins.

The demolding agents are used as a mixture constituent preferably in amounts of about 0.1 to 10 phr, more preferably 0.5 to 5 phr, based on 100 phr of the elastomer(s) in the rubber component.

In a preferred execution, the present invention relates to a directly adhering composite composed of at least one part produced from at least one polyamide molding compound and at least one elastomer part, characterized in that the polyamide molding compound contains at least 30% by weight of a mixture of
a) 60 to 99.9 parts by weight of PA6 or PA66 and
b) 0.1 to 40 parts by weight of a mixture of at least one polybutadiene having a number-average molecular weight Mn in the range from 800 to 20 000 g/mol and/or having a dynamic viscosity measured by the cone-plate method to DIN 53019 at standard pressure and at a temperature of 25° C. in the range from 100 to 15 000 mPas with 1,8-trans-polyoctenamer,
   where the sum total of the parts by weight of a) and b) is 100 and at least one rubber from the group of NR, EPDM, NBR, CR, BR, SBR, XNBR which is to be crosslinked with elemental sulfur as crosslinking agent is used for the elastomer part.

In a preferred execution, the present invention relates to a directly adhering composite composed of at least one part produced from at least one polyamide molding compound and at least one elastomer part, characterized in that the polyamide molding compound contains at least 30% by weight of a mixture of
a) 60 to 99.9 parts by weight of PA6 and
b) 0.1 to 40 parts by weight of a mixture of at least one polybutadiene having a number-average molecular weight Mn in the range from 800 to 20 000 g/mol and/or having a dynamic viscosity measured by the cone-plate method to DIN 53019 at standard pressure and at a temperature of 25° C. in the range from 100 to 15 000 mPas with 1,8-trans-polyoctenamer,
   where the sum total of the parts by weight of a) and b) is 100 and at least one rubber from the group of NR, EPDM, NBR, CR, BR, SBR, XNBR which is to be crosslinked with elemental sulfur as crosslinking agent is used for the elastomer part.

In a preferred execution, the present invention relates to a directly adhering composite composed of at least one part produced from at least one polyamide molding compound and at least one elastomer part, characterized in that the polyamide molding compound contains at least 30% by weight of a mixture of
a) 60 to 99.9 parts by weight of PA66 and
b) 0.1 to 40 parts by weight of a mixture of at least one polybutadiene having a number-average molecular weight Mn in the range from 800 to 20 000 g/mol and/or having a dynamic viscosity measured by the cone-plate method to DIN 53019 at standard pressure and at a temperature of 25° C. in the range from 100 to 15 000 mPas with 1,8-trans-polyoctenamer,
   where the sum total of the parts by weight of a) and b) is 100 and at least one rubber from the group of NR, EPDM, NBR, CR, BR, SBR, XNBR which is to be crosslinked with elemental sulfur as crosslinking agent is used for the elastomer part.

In a preferred execution, the present invention relates to a directly adhering composite composed of at least one part produced from at least one polyamide molding compound and at least one elastomer part, characterized in that the polyamide molding compound contains at least 30% by weight of a mixture of
a) 60 to 99.9 parts by weight of PA6 and
b) 0.1 to 40 parts by weight of a mixture of at least one polybutadiene having a number-average molecular weight Mn in the range from 800 to 20 000 g/mol and/or having a dynamic viscosity measured by the cone-plate method to DIN 53019 at standard pressure and at a temperature of 25° C. in the range from 100 to 15 000 mPas with 1,8-trans-polyoctenamer,
   where the sum total of the parts by weight of a) and b) is 100 and EPDM rubber which is to be crosslinked with elemental sulfur as crosslinking agent is used for the elastomer part.

In a preferred execution, the present invention relates to a directly adhering composite composed of at least one part produced from at least one polyamide molding compound and at least one elastomer part, characterized in that the polyamide molding compound contains at least 30% by weight of a mixture of
a) 60 to 99.9 parts by weight of PA66 and
b) 0.1 to 40 parts by weight of a mixture of at least one polybutadiene having a number-average molecular weight Mn in the range from 800 to 20 000 g/mol and/or having a dynamic viscosity measured by the cone-plate method to DIN 53019 at standard pressure and at a temperature of 25° C. in the range from 100 to 15 000 mPas with 1,8-trans-polyoctenamer,
   where the sum total of the parts by weight of a) and b) is 100 and EPDM rubber which is to be crosslinked with elemental sulfur as crosslinking agent is used for the elastomer part.

Preferably, in the embodiments mentioned here, the polyoctenamer and the polybutadiene are used in a mass ratio to one another of 1 part polyoctenamer:4 parts polybutadiene to 4 parts polyoctenamer:1 part polybutadiene.

Finally, the invention also relates to a process for producing a directly adhering composite composed of at least one part produced from at least one polyamide molding compound and at least one part produced from at least one elastomer, preferably obtainable from rubber to be vulcanized or crosslinked with elemental sulfur as crosslinking agent, and preferably without any adhesion promoter, by at least one shaping method from the group of extrusion, flat film extrusion, film blowing, extrusion blow molding, coextrusion, calendering, casting, compression methods, injection embossing methods, transfer compression methods, transfer injection compression methods or injection molding or special methods thereof, especially gas injection methodology, either by contacting the part composed of the polyamide molding compound with a rubber component or exposing it to the vulcanization conditions of the rubber, or by contacting the part composed of rubber with a polyamide molding compound, with the molding compound for at least one part, preferably the polyamide molding compound, comprising the mixture of polyoctenamer and polybutadiene.

The present invention also relates, however, to the use of a mixture of polyoctenamer and polybutadiene for production of a directly adhering composite from at least one part composed of at least one polyamide molding compound and at least one part composed of at least one elastomer, preferably obtainable from rubber to be vulcanized or crosslinked with elemental sulfur, wherein the mixture is used in the molding compound of at least one part, preferably in the polyamide molding compound.

### EXAMPLES

### 1. Polyamide Components Used:

The compositions of the polyamide components are summarized in Table 1.

The constituents of the polyamide components are stated in parts by mass based on the overall molding composition.

TABLE 1
Composition of the polyamide molding composition for the polyamide-
based component of the composite

| | Polyamide component | | | | |
|---|---|---|---|---|---|
| | 1 | 2 | 3 | 4 | 5 |
| Constituent A | 95 | 95 | 95 | 95 | 95 |
| Constituent B | 5 | 0 | 1 | 2.5 | 4 |
| Constituent C | 0 | 5 | 4 | 2.5 | 1 |
| Sum total of the | 5 | 5 | 5 | 5 | 5 |
| proportions by mass of | | | | | |
| constituents B and C | | | | | |

Product names and manufacturers of the constituents of the polyamide components in Table 1:
Constituent A=Durethan® BKV30 H2.0 901510 from LANXESS Deutschland GmbH, Cologne, with ISO molding compound designation ISO 1874-PA6, GHR, 14-090, GF 30, a heat-stabilized nylon-6 with 30% added glass fibers
Constituent B=polyoctenamer, Vestenamer® 8012 (1,8-trans-polyoctenamer), 80% trans, weight-average molecular weight Mw 90 000 g/mol, Tₘ=54° C., 30% crystalline (manufacturer data), from Evonik Industries AG, Marl
Constituent C=polybutadiene, LBR-307B (liquid polybutadiene) having a dynamic viscosity at 25° C. (DIN 53019) of 2210 mPas and a weight-average molecular weight Mw in the region of 8000 g/mol (manufacturer data) from Kuraray Europe GmbH, Hattersheim am Main

### Production of the Polyamide Components in Table 1:

The constituents of the polyamide components 1 to 5 according to table 1 were mixed to give polyamide molding compounds in a Leistritz ZSE 27 MAXX twin-screw extruder from Leistritz Extrusionstechnik GmbH, Nuremberg. For all the polyamide components, the compounding was conducted at a melt temperature of 260 to 300° C. and with a throughput of 8 to 60 kg/h. The melt was discharged as a strand into a water bath and then pelletized. After compounding, the polyamide molding compounds were dried at 80° C. in a dry air dryer for 4 hours before they were then processed in an injection molding operation.

Table 2 lists the resulting mass ratios of polyoctenamer to polybutadiene for the polyamide components 1 to 5.

TABLE 2
Mass ratios of polyoctenamer to polybutadiene of
polyamide components 1 to 5

| | Polyamide component | | | | |
|---|---|---|---|---|---|
| | 1 | 2 | 3 | 4 | 5 |
| Parts of polyoctenamer | 5 | 0 | 1 | 1 | 4 |
| Parts of polybutadiene | 0 | 5 | 4 | 1 | 1 |

### 2. Elastomer Components Used:

The compositions of the rubber mixtures of the elastomer components that result after vulcanization are summarized in Table 3.

The rubber mixture constituents of the elastomer components are stated in parts by mass based on 100 parts by mass of rubber.

TABLE 3
Composition of the rubber mixtures of the elastomer components that
result after vulcanization

| | Elastomer component |
|---|---|
| | A |
| Keltan ® 2450 | 100 |
| N550 | 60 |
| PEG-4000 | 5 |
| Sunpar ® 2280 | 5 |
| Stearic acid | 3 |
| ZnO | 5 |
| Sulfur | 0.7 |
| TBBS | 1 |
| TBzTD-70 | 3.5 |

Product names and manufacturers of the rubber mixture constituents in Table 2:
Keltan® 2450=ethylene-propylene-diene rubber (EPDM) from LANXESS Deutschland GmbH, Cologne
N550=Corax® N550 industrial carbon black from Orion Engineered Carbons GmbH
PEG-4000=polyethylene glycol, CAS No. 25322-68-3, plasticizer from Carl Roth GmbH & Co. KG, Karlsruhe
Sunpar® 2280=paraffinic plasticizer oil from Schill & Seilacher “Struktol” GmbH, Hamburg. The composition is specified by SUNOCO as a mixture of carefully refined paraffinic oils, CAS No. 64742-62-7/64742-65-0.
Stearic acid=Edenor® ST4A stearic acid from BCD-Chemie GmbH, Hamburg
ZnO=Zinkweiss Rotsiegel zinc oxide from Grilio-Werke AG, Goslar
Sulfur 90/95 ground sulfur as vulcanizing agent from SOLVAY GmbH, Hanover
TBBS=Vulkacit NZ vulcanization accelerator from LANXESS Deutschland GmbH, Cologne, CAS No. 102-06-7.
TBzTD-70=Rhenogran® TBzTD-70 polymer-bound vulcanization accelerator from Rhein Chemie Rheinau GmbH, Mannheim, contains tetrabenzylthiuram disulfide CAS No. 10591-85-2.

The rubber mixtures were produced by means of a Werner & Pfleiderer GK 5E laboratory internal mixer.

3. Production of the Composite Specimens from Polyamide Component and Elastomer Component by Means of 2-Component Injection Molding:

To detect the rise in bond strength through the inventive combination of materials, composite specimens were produced in a multicomponent injection molding process. An Engel Combimelt 200H/200L/80 2-component injection molding machine from Engel Austria GmbH, Schwertberg, Austria was used, and the injection mold used was a 2-cavity turntable mold.

The 2K injection molding process was operated in two stages, i.e. first production of the polyamide component by injection molding, dry and dust-free storage of the polyamide component for 24 h and reinsertion of the polyamide component into the elastomer mold cavity of the 2K injection molding machine for overmolding with the rubber component, and subsequent vulcanization. The polyamide component was preheated to the elastomer mold temperature for 20 min prior to reinsertion into the mold.

In the thermoplastic cavity of the injection mold, a 60 mm*68 mm*4 mm PA sheet was produced by injection molding. The rubber cavity had the dimensions 140 mm*25 mm*6 mm and formed an overlap with respect to the thermoplastic sheet of 44.5 mm*25 mm.

The polyamide component of the composite specimens was produced with the following injection molding settings: barrel temperature 270/275/275/270/265° C., injection rate 15 cm³/s, mold temperature 85° C., hold pressure 450 bar, hold pressure held for 20 s, cooling time 15 s.

The elastomer component of the composite specimens was produced with the following injection molding settings: barrel temperature 100° C., injection rate 7 cm³/s, mold temperature 165° C., hold pressure 300 bar, hold pressure held for 90 s, vulcanization time 10 min.

4. Testing of the Composite Specimens from Polyamide Component and Elastomer Component by Means of a Peel Test:

After storage of the composite specimens based on the compositions of polyamide components 1 to 5 and elastomer component A for at least 24 hours, these were subjected to a 90° peel test to test the bond strength. The peel test was conducted on the basis of DIN ISO 813 using a Zwick Z010 universal tester from Zwick GmbH & Co. KG, Ulm, Germany. In this test, the composite specimen was clamped at an angle of 90° in a tensile tester with a special device to accommodate the thermoplastic component—a polyamide component here—and placed under tensile stress. The pretensioning force was 0.3 N, the testing speed 100 mm/min. The bond strength is obtained from the maximum force measured in N based on the width of the elastomer component of 25 mm.

The results of the peel tests on the composite specimens of polyamide components 1 to 5 and elastomer component A, i.e. the resulting bond strengths, are summarized in table 4.

TABLE 4
Results of the peel tests of the composite specimens
composed of polyamide component and elastomer
component, expressed in the resulting bond strength

| | Elastomer component |
|---|---|
| Polyamide component | A |
| 1 | 7.8 N/mm |
| 2 | 3.6 N/mm |
| 3 | 14.5 N/mm |
| 4 | 17.0 N/mm |
| 5 | 16.9 N/mm |

The composite specimens composed of polyamide components 1 and 2 exhibited bond strengths of >3 N/mm. The composite specimens composed of polyamide components 3, 4 and 5 had significantly higher bond strengths. The bond strengths here were about twice to five times higher compared to polyamide components 1 and 2.

In summary, table 4 thus shows that the inventive use of a mixture of polyoctenamer and polybutadiene in the polyamide component significantly increased the bond strength.

1. A mixture of polyoctenamer and polybutadiene.

2. The mixture as claimed in claim 1, wherein the polybutadiene has a number-average molecular weight Mn of 800 to 20,000 g/mol and/or a dynamic viscosity, measured by the cone-plate method to DIN 53019 at standard pressure and at a temperature of 25° C., of 100 to 15,000 mPas.

3. A directly adhering composite composed of at least one part produced from at least one polyamide molding compound and at least one part produced from at least one elastomer, wherein at least one part comprises the mixture as claimed in claim 1.

4. The composite as claimed in claim 3, wherein the composite comprises the mixture in the part produced from the polyamide molding compound.

5. The composite as claimed in claim 3, characterized in that the polyamide molding compound comprises, to an extent of at least 30% by weight, a mixture of
a) 60 to 99.9 parts by weight of polyamide and
b) 0.1 to 40 parts by weight of polyoctenamer and polybutadiene,
wherein the sum total of the parts by weight of a) and b) is 100 in the polyamide molding compound, and the elastomer part is produced from rubber to be crosslinked or vulcanized with elemental sulfur as crosslinking agent.

6. The mixture as claimed in claim 1, wherein the polyoctenamer is 1,8-trans-polyoctenamer.

7. The composite as claimed in claim 3, wherein the polybutadiene has a number-average molecular weight Mn of 800 to 20,000 g/mol and/or a dynamic viscosity, measured by the cone-plate method to DIN 53019 at standard pressure and at a temperature of 25° C. in the range from 100 to 15,000 mPas, preferably in the range from 550 to 4500 mPas, is used.

8. The composite as claimed in claim 5, wherein the rubber to be crosslinked with elemental sulfur as crosslinking agent is selected from the group consisting of natural rubber, ethylene-propylene-diene rubber, vinylaromatic/diolefin rubber, polybutadiene rubber, polyisoprene, butyl rubber, halobutyl rubber, nitrile rubber, hydrogenated nitrile rubber, carboxylated butadiene/acrylonitrile rubber, and polychloroprene.

9. The composite as claimed in claim 8, wherein the vinylaromatic/diolefin rubber is styrene/butadiene rubber.

10. The composite as claimed in claim 8, wherein the halobutyl rubber is chloro- or bromobutyl rubber.

11. The composite as claimed in claim 3, wherein the polyamide is PA6 or PA66.

12. The composite as claimed in claim 3, wherein the polyamide is PA6 and the rubber to be crosslinked with sulfur used is ethylene-propylene-diene rubber.

13. The composite as claimed in claim 3, wherein the polyoctenamer and polybutadiene are in a mass ratio of 1 part polyoctenamer:20 parts polybutadiene to 30 parts polyoctenamer:1 part polybutadiene.

14. The composite as claimed in claim 3, wherein the composite does not need any additional adhesion promoter.

15. A product comprising the at least one composite as claimed in claim 3.

16. The product as claimed in claim 15, characterized in that it is a seal, membrane, gas pressure storage means, hose, housing for a motor, pump or electrically operated tool, roller, tire, coupling, buffer stop, conveyor belt, drive belt, multilayer laminate or multilayer film, or a sound- and vibration-dampening component.

17. A process for producing a directly adhering composite composed of at least one part produced from at least one polyamide molding compound and at least one part produced from at least one elastomer by at least one shaping method from the group of extrusion, flat film extrusion, film blowing, extrusion blow molding, coextrusion, calendering, casting, compression methods, injection embossing methods, transfer compression methods, transfer injection compression methods or injection molding or special methods thereof, either by contacting the part composed of the polyamide molding compound with a rubber component and exposing it to the vulcanization conditions of the rubber, or by contacting the part composed of rubber with a polyamide molding compound, with at least the molding compound or a part, preferably the polyamide molding compound, comprising the mixture of polyoctenamer and polybutadiene.

18. The use of a mixture of polyoctenamer and polybutadiene for production of a directly adhering composite composed of at least one part composed of at least one polyamide molding compound and at least one part composed of at least one elastomer, characterized in that the mixture is used in the molding compound of at least one part, preferably in the polyamide molding compound.

19. The composite as claimed in claim 3, wherein the polyoctenamer is 1,8-trans-polyoctenamer.
